(19) United States
(12) Patent Application Publication
(10) Pub. No.: US 2011/0145168 A1
(43) Pub. Date: Jun. 16, 2011

(54) Apparatus for Energy-Efficient Estimation of a Yield of a Financial Product

(75) Inventors: Stefen Dirnstorfer, Munich (DE); Andreas Grau, Muenchen (DE)

(73) Assignee: Thetaris GmbH, Munich (DE)

(21) Appl. No.: 12/974,507

(22) Filed: Dec. 21, 2010

Related U.S. Application Data
(63) Continuation-in-part of application No. PCT/EP2009/004829, filed on Jul. 3, 2009.
(60) Provisional application No. 61/133,918, filed on Jul. 3, 2008.

(51) Int. Cl. G06Q 40/00

(52) U.S. Cl. 705/36 R

(57) ABSTRACT

An apparatus for estimating a yield of a financial product, as well as to a corresponding method and a corresponding computer program product. The present disclosure can be loosely summarized, in one aspect, as teaching a method of pricing a financial product under a number of potential future scenarios wherein, instead of carrying out a separate (and perhaps nested) Monte Carlo simulation for each scenario under consideration, a smoothing function is generated from the results of a proportionately small number of representative (nested) simulations and the pricing is estimated at each scenario using the smoothing function. Each Monte Carlo simulation simulates the yield of the financial product under the conditions of the specific scenario. Accordingly, the smoothing function represents the (simulation) yield of the financial product as a function of the scenario parameters.

### CROSS-REFERENCE TO RELATED APPLICATIONS

This application claims the benefit under 35 U.S.C. §119 of U.S. Provisional Application No. 61/133,918, filed on Jul. 3, 2008, and is a continuation-in-part of PCT application PCT/EP2009/004829 filed on Jul. 3, 2009, the entire disclosure of these documents are herein expressly incorporated by reference.

### BACKGROUND OF THE INVENTION

1. Field of the Invention

The present invention relates to an apparatus for estimating a yield of a financial product, as well as to a corresponding method and a corresponding computer program product. Specifically, the invention provides an energy efficient transformation of data indicative of observed market behavior into a numeric estimate of a yield of a financial product under various future market scenarios having regard for the terms of the financial product.

2. Description of the Related Art

In the world of engineering, in particular electrical and software engineering, many problems of discrete mathematics are known that, although deterministic and dependent only on a relatively small number of variables, cannot yet be solved exactly without computing each of the possible solutions, i.e. for which no analytical solution is known. Accordingly, the computational burden of such problems increases extremely quickly, e.g. exponentially or factorially, with the number of variables and can easily far exceed the capabilities of even the fastest computational facilities. A well-known such problem from the realm of discrete mathematics is the so-called travelling salesman problem in which the shortest route between a plurality of cities must be found. Clearly, the distance travelled is easily computed; it is simply the sum of the distance between the respective cities in the order travelled. Nonetheless, the difficulty of finding the shortest route increases factorially. Even for just 25 cities, there are over 1.5×10²⁵ possible paths. Putting that into a comprehensible perspective, the top ranked supercomputer in 2008 was capable of 1.1 petaflops (one thousand one hundred trillion floating point operations per second). Calculating at that speed, it would require 14 billion seconds to calculate each and every possible path between 25 cities. That's roughly four hundred and forty years!

Since such problems are not solvable by brute computation, it is necessary to estimate a solution. Whereas an experienced traveler will be able to find a reasonably good solution, i.e. one that does not differ disproportionately from the optimal solution, to the travelling salesman problem using common sense, other problems are not as easily estimated by heuristic techniques. Moreover, the heuristic techniques that may be useful in finding a reasonable estimate with regard to one problem are not typically applicable to other problems. For example, an experienced travel would recognize that travelling to Tokyo on their way from New York to Washington D.C. is likely to increase the total distance travelled. However, if the problem to be solved is to design a CPU having maximal performance in terms of floating point operations per second without exceeding a given size and a given thermal envelope, is it better to add line buffers, to increase the number of pipeline stages or to increase the parallelism with the floating point computational units if one has a bit of space and power to spare? Clearly, the traveler's experience does not assist in solving this question.

Having regard for this background, it has become popular to employ stochastic techniques, also known as Monte-Carlo techniques, as a general-purpose approach for estimating acceptable solutions to discrete mathematical problems that cannot be solved analytically. The term Monte-Carlo stems from the fact that such techniques are based on one or more random variables, i.e. encompass elements of chance. One such Monte-Carlo technique is a random search through the solution space, i.e. through the various possible solutions. Typically, such a random search is carried out for a fixed number of possible solutions or until a seemingly acceptable solution is found. Yet for problems having an extremely large solution space and/or strong interdependency between the input parameters (as in the aforementioned CPU example), the computational burden associated with Monte-Carlo techniques can be unreasonably large. The computational burden not only has an impact on the amount of time necessary to find an acceptable solution, but also on the size and the power consumption of the computational facilities. All of these factors moreover constitute a financial burden for the afflicted industry.

The financial industry, e.g. banks and insurance companies, is strongly affected by the aforementioned, computational burden of discrete mathematical problems not solvable by analytic methods. This burden arises, for example, in the context of risk management, where the pricing of a financial product (in the present application, the term “financial product” is to be understood as including all types of financial products, including e.g. derivatives) must be estimated for a large number of potential future scenarios.

In such estimations, observable market parameters are simulated according to statistical properties based on historical observations. The simulated scenarios represent potential future values for which a financial institution must prepare. Since each financial product in a large portfolio acts differently to changes in market parameters, each product's price must be evaluated under each scenario.

A number of regulatory provisions require financial institutions to perform a valuation of their portfolio under each potential future scenario. The accuracy and speed with which such evaluations can be performed is crucial to the companies' financial success. As regulated by the European Basel II directive, each bank must back its risky investments with risk-less assets such as government bonds. Since risky assets are generally expected to yield higher profits, banks are interested in measuring each asset's risk as accurately as possible. If a bank has failed to accurately estimate its risks, it is required to counterbalance a larger percentage of its risk capital with risk-less assets, consequently reducing the bank's ability to leverage its assets on the market. While Basel II is focused on the banking sector, similar regulations are planned for the insurance industry as proposed by Solvency II.

The current Basel II regulation requires a portfolio to be evaluated under a number of potential future scenarios. For each scenario, the development of all portfolio positions must be determined at several time steps, i.e. at several points in time. It is currently best practice to randomly simulate future market parameters for each scenario and each time step. In a typical setting with 250 time steps and 5000 paths, i.e. 5000 different presumptions specified by the regulatory authorities about how the relevant market parameters could develop over each of those 250 future time steps, the total number of evaluations is given by 5000×250=1.25 million prices for each financial product in the portfolio. The estimation of each such price is typically done by calculating, by means of a multi-step Monte Carlo technique, on the order of ten thousand possible paths with typically a few hundred internal steps from one time step to the next for each of the parameters that influences the price of the financial product and then estimating an appropriate value for each such parameter at the next time step based on the calculated paths. Accordingly, the evaluation of each product requires on the order of 1.25 million×10 thousand×100, i.e. over 1.2 trillion calculations. On prevailing computer hardware with a single processor, a single such product evaluation can take several days to compute.

A brief summary of prior art techniques for portfolio evaluation, i.e. for estimating a yield of financial products, is given hereinbelow.

Depending on the instrument type and the time horizon of the risk estimation, the risk assessment of a product position in a portfolio can be conducted in several ways. In any case, risk is measured by a characteristic number, e.g. value at risk (VaR), conditional value at risk (CVaR) or standard deviation.

For a short time horizon, a risk estimate based on the sensitivities of the product with respect to the underlying (“Delta” and “Gamma”) delivers fast and accurate results without the need of simulation. However, this sensitivity-based approach fails to estimate risks accurately when the remaining maturity time of the product is short or when the risk estimate for several weeks ahead has to be computed.

Estimating the market risk for long time spans, a simulation of the risk factors has to be conducted, and at each time step of each scenario, the portfolio has to be evaluated. This is easy if a fast pricing method for the specific instrument type exists, e.g. an analytic solution for the price. However, for many instrument types, only computationally expensive simulation methods exist, especially for Basket or path-dependent options. The cost of a simulation of the risk factors and a nested simulation for the product prices is in many realistic settings prohibitively high such that different solutions have been proposed to mitigate this problem. Several prominent proposals are:
1. Usage of variance reduction techniques in the nested Monte Carlo simulation. Many variance reduction techniques have been proposed, e.g. control variables, low discrepancy sequences [Traub et al 1999] and importance sampling [Glasserman 2003]. But, the speed-up using the variance reduction techniques—typically between 2 and 10—is by far not sufficient for a nested simulation estimating market risk.
2. Portfolio compression, which creates a new portfolio with the same risk properties as the considered portfolio but with fewer instruments [Dembo 1998]. This approach helps to some extend by reducing the number of instruments to price, but this technique is often not applicable to complex structured products.
3. Risk estimation by combinatorial scenario simulation, which effectively reduces the number of physical scenarios in settings with many risk factors. For each of the s risk factors, only a small number n of physical scenarios is computed. Then, the whole setting of the physical simulation is created by computing all possible combinatorial combinations of the risk factors. Then, a Monte Carlo simulation along these pre-computed risk factor realizations is performed to estimate the portfolio risk. This reduces the required number of option valuations considerably, but shows slow convergence [Abken 2000].
4. Importance sampling, which computes scenario samples that are of particular importance for the risk measure to estimate and shifts the scenario weights such that the estimate of the risk measure is unbiased [Glassermann 2000]. This technique can improve the accuracy of risk estimates considerably but the speed-up is often still not sufficient for nested Monte Carlo simulations.
5. Usage of few paths is another method for mitigating the computational burden. It turns out that if at each of the physical paths, a nested simulation with e.g. 100 paths is conducted (where e.g. 10,000 would be needed for a precise option price estimate) can already lead to sufficiently precise risk estimates. The reason for this is that the errors in the option price estimations mutually annihilate almost completely and the few paths are sufficient for estimates of the risk measure. However, the resulting risk-measure estimate is biased and has to be corrected in a post process for precise estimates. [Gordy and Juneja 2008]

Since banks have portfolios with thousands of financial products, the computational challenge involved in portfolio evaluation is enormous. There are several financial products, such as European options or futures for which extremely fast algebraic evaluations can be performed. Other financial products can be efficiently priced by solving an associated partial differential equation. Other products, especially those that depend on a large number of traded instruments, e.g. basket options, can only be solved with a Monte Carlo approach. As discussed above, a single Monte Carlo evaluation can take several minutes to compute. This is far too slow to be acceptable to the industry. The problem can be only partially mitigated through the use of multi-processor machines, since the evaluation must be performed for each individual financial asset in the portfolio. The cost and size of today's computing hardware is already at a maximum in many banks, while the risks of many exotic derivatives are often computed incorrectly.

In light of the aforementioned shortcomings of the prior art, it is an object of the present invention to provide a massive acceleration of Monte-Carlo based pricing techniques for financial products, consequently dramatically reducing not only the required computing time, but also the costs for maintenance and energy.

### SUMMARY OF THE INVENTION

The present invention provides a method for estimating a yield of a financial product in accordance with independent claim 1. Preferred embodiments of the invention are reflected in the dependent claims.

The present disclosure can be loosely summarized, in one aspect, as teaching a method of pricing a financial product under a number of potential future scenarios wherein, instead of carrying out a separate (and perhaps nested) Monte Carlo simulation for each scenario under consideration, a smoothing function is generated from the results of a proportionately small number of representative (nested) simulations and the pricing is estimated at each scenario using the smoothing function. Each Monte Carlo simulation simulates the yield of the financial product under the conditions of the specific scenario. Accordingly, the smoothing function represents the (simulated) yield of the financial product as a function of the scenario parameters. The smoothing technique can be e.g. non-parametric regression or kernel smoothing.

The present disclosure encompasses not only the above method, but also a corresponding apparatus as well as a corresponding computer program product. The present disclosure equally encompasses a method of operating a computer or other computational device to effect the steps/techniques described herein.

In accordance with the present disclosure, the term “computer program product” is to be understood as encompassing any tangible or intangible product comprising instructions suitable for effecting, e.g. when executed by a computer or other computational apparatus, the stipulated features/functionality. Such products include, but are not limited to, physical storage media (e.g. CD's, DVD's, magnetic and/or optical storage media, flash memory, etc.) storing such instructions. Such products also include what are commonly known as downloads, i.e. a purely electromagnetic representation of such instructions. Such representations may be distributed, i.e. available to a user from a plurality of sources, each source providing only a part of the representation in electromagnetic form to a user apparatus, the full instructions thus only being recreated at the user apparatus. Access to such downloads is typically restricted to authorized users via a password, access code or other identification/authorization means. Accordingly, the provision of such access is to be considered as offering the computer program product that thus becomes available.

Although the present disclosure makes no limitations with regard to the types of financial products it can be applied to for estimating a yield of the financial product, it is particularly suited for estimating a yield of financial products whose yield could not heretofore be calculated or estimated by analytical techniques, e.g. by algebraic techniques or by solving (partial) differential equations.

A financial product in the sense of the present disclosure is a product whose future value, e.g. tradeable monetary value, depends on and, at least in part, is unambiguously defined by one or more future market factors of the financial market in its broadest sense. Such market factors include, but are not limited to, the Dow Jones index, the price of oil or other traded commodities, the inflation rate, weather conditions, foreign or domestic consumer indices, foreign or domestic debt, foreign or domestic GNP and the exchange rate of one or more major currencies. Since such market factors influence the value of financial products, they are often referred to in the art as risk factors.

Derivatives are typical examples of such financial products. Derivatives are financial instruments whose values are derived from the value of one or more other things, so-called underlyings.

One such derivative is a basket option. In finance, an option is a contract between a buyer and a seller that gives the buyer the right—but not the obligation—to buy or to sell a particular, underlying asset at a later date at an agreed price. In return for granting the option, the seller collects a payment from the buyer. If the buyer chooses to exercise this right, the seller is obliged to sell or buy the asset at the agreed price. However, the buyer may choose not to exercise the right during the lifetime of the contract, i.e. may allow the right to lapse. The underlying asset can be a piece of property, a futures contract, shares of stock or some other security. Since the actual price of the underlying asset at the time the buyer may choose to exercise the option will typically differ from the agreed price, the seller bears a certain risk. A basket option is an option relating to a plurality of underlying assets. Accordingly, the risk associated with a basket option is dependent on multiple factors.

It is not unusual for derivatives to be path dependent. For example, an option will typically allow the buyer full freedom to exercise the option, i.e. to buy or sell the respective asset(s) from/to the seller, throughout the lifetime of the option. Similarly, an option may limit the buyer's right to buy/sell the respective asset(s) to a specified amount/number within a particular timeframe, e.g. within the lifetime of the option.

Presuming that the option allows the buyer to buy up to 1000 shares of a particular stock from the seller within the lifetime of the option and the buyer exercises the option by buying 400 shares of that stock from the seller mid-way through the lifetime of the option, the value of the option after such exercise will be dependent not only on the price paid by the seller for the 400 shares, but also on the value of those 400 on the date the option was exercised, i.e. on the earnings/loss for the buyer by virtue of their exercise of the option with respect to the 400 shares. The value of the option after such exercise will also be affected due to the fact that only 600 shares remain for possible exercise.

Accordingly, a financial product in accordance with the present disclosure may be a product whose future value depends on and is unambiguously defined by one or more future market factors and exercise of the product during the lifetime of the product. As such, a yield of such a financial product can be generally defined as a function of a plurality of variables and time, viz. as a function of the aforementioned one or more future market factors, including variables reflecting such potential exercise of the product and time.

In accordance with an aspect of the present disclosure, several of the calculations taught herein are carried out in a multidimensional space having such a plurality of variables and time as coordinates, i.e. having no more and no less coordinates than the aforementioned plurality of variables and time. Naturally, the person skilled in the art will readily recognize that any of the calculations can be carried out just as well in a lesser dimensional space via appropriate division of the respective calculations into lesser-dimensional sub-problems followed by appropriate (re)combination of the respective, lesser-dimensional results. Similarly, the calculations can be carried out in a higher dimensional space without compromising the utility of the techniques and calculations taught herein. Accordingly, all references to calculations in a multidimensional space are to be considered exemplary, not limiting.

As described in the introductory portion of this disclosure, it is an aim of the present disclosure to estimate the yield of a financial product under various potential future scenarios in an accelerated manner. In the nomenclature of the present disclosure, the term “scenario” is to be understood in the sense of a group of assumed market factor values at a particular time. In other words, each scenario can be represented as a singular point in a multidimensional space having a plurality of market factors and time as coordinates. The market factors for which a corresponding market factor value is given by a particular scenario may include, but is not limited to, the market factors that define the financial product. In other words, the market factors that define the financial product may be a subset of or identical to the market factors whose assumed values define the scenario. Accordingly, the aforementioned multidimensional space for calculations may be a subspace of or identical to the multidimensional space in which the scenario can be represented as a point. In accordance with another aspect of the present disclosure, various scenarios may be given as separate points in the same multidimensional space.

The present disclosure uses the term “scenario path” to describe a sequence of scenarios over time. Simulation of the market, e.g. by Monte Carlo simulation as described in greater detail infra, is then carried out at one or more points along each scenario path. Moreover, as likewise described in greater detail infra, such simulation of the market can be used to determine the next scenario in the sequence, i.e. to extend the scenario path.

In layman's terms, each scenario path constitutes a representation of how the market could conceivably develop over time, i.e. a sequence of possible scenarios. In fact, the present disclosure teaches techniques for constructing a scenario path that is a statistically “realistic” representation of how the market could develop over time.

A scenario path need not be continuous, i.e. may be discontinuous. For example, a scenario path may be represented by (a sequence of) individual points in the multidimensional space. A scenario path may likewise be represented by one or more continuous lines, e.g. as defined by one or more functions, through the multidimensional space, or by a mixture of lines and individual points.

Each scenario path defines only one scenario/point for a given point in time as measured along the temporal axis of the multidimensional space. In other words, a cross-section through the multidimensional space perpendicular to the temporal axis will intersect a respective scenario path one time at most.

In accordance with the present disclosure, a yield of a financial product can be estimated by pricing the financial product at one or more potential future scenarios. In the present disclosure, the expression “pricing a financial product” designates an estimation of the price, i.e. the fair market value, of the financial product for a potential market scenario, i.e. for a plurality of potential market factors, obtained e.g. by Monte Carlo simulation. As described above, the yield of the financial product may be partially or fully defined with respect to the market factors constituting the potential scenarios by virtue of the very nature of the financial product, i.e. by the terms of a contract underlying the financial product.

If desired, the yield of the financial product at a particular future scenario may be discounted having regard for one or more events that have occurred at an earlier point in time, e.g. at an earlier scenario point along the same scenario path as the particular future scenario, where the events, e.g. the exercise of a sell or purchase option, impact the value of the financial product. In other words, the yield of the financial product at a particular future scenario may be discounted having regard for the simulated history of the financial product, i.e. for the market behavior encountered by the financial product as simulated at one or more earlier scenarios along the scenario path to which the particular future scenario belongs.

In one embodiment, the present disclosure provides an apparatus for estimating yield of a financial product, the apparatus having calculating circuitry. The calculating circuitry can be embodied in any form known in the art. For example, the calculating circuitry can be embodied in the form of one or more central processing units (CPU's) and/or floating-point unit (FPU's) and can include cache or other memory for storing operands and/or (intermediate) computational results. The calculating circuitry can be equally embodied in the form of dedicated hardware. Although such hardware is not described in the present disclosure in detail, the person skilled in the art of calculating circuitry, having regard for the other teachings of this disclosure, would have no difficulty implementing hardware dedicated to effecting solely the techniques described herein.

The present disclosure teaches a first set of data indicative of a yield of said financial product as a function of a plurality of variables and time. The set of data can be embodied in any form known in the art. For example, the data can be provided in binary form. As described in greater detail supra, a future value of a financial product in the sense of the present disclosure is, at least in part, unambiguously defined by one or more future market factors, i.e. one or more variables and time. A yield of a financial product depends, inter alia, on the value of the financial product under the given market circumstances. Accordingly, the first set of data may be at least partially indicative of the relationship between the future value of the financial product and one or more future market factors. For example, the first set of data may reflect, in binary or other computer-readable form, the terms of an option, i.e. the contract between the buyer and the seller of an option.

The present disclosure teaches a first plurality of points in a multidimensional space having a plurality of variables and time as coordinates. As discussed hereinabove, financial institutions are often required by regulatory agencies to estimate the yield of financial products in their portfolio under various potential market scenarios. Each such potential market scenario can be at least partially represented as a point in a multidimensional space having a plurality of variables, e.g. variable market factors, and time as coordinates.

The present disclosure teaches calculation of a yield of the product at each of a second plurality of points in a multidimensional space based on the first set of data. By definition, the first set of data is indicative of a yield of said financial product as a function of a plurality of variables and time that constitute the coordinates of the multidimensional space. It follows that a yield of the financial product can be calculated, e.g. by means of a Monte Carlo simulation, at each of a second plurality of points in the multidimensional space based on the first set of data. In practice, however, as elucidated in detail in the discussion of the prior art supra and the discussion of exemplary embodiments infra, such calculation/simulation is computationally expensive.

The present disclosure teaches generation of an approximation function having at least said plurality of variables as input parameters, i.e. arguments, the function approximating, for each respective one of the aforementioned second plurality of points, the calculated, i.e. simulated, yield at the respective one of the second plurality of points. The present disclosure moreover teaches estimation of a yield of the financial product at each of the first plurality of points based on the approximation function. The inventors of the present invention have found that an approximation function that approximates a yield of a financial product, calculated in a computationally intensive manner, at a plurality of points in a multidimensional space can be used for estimating a yield of the financial product at other points in that multidimensional space.

The present disclosure places no limitations on the form of the approximation function. The approximation function may be a continuous or a discontinuous function and may be defined using, for example, one or more polynomials and/or one or more trigonometric functions. For the sake of computational speed, the approximation function may be a fifth or lesser degree polynomial.

Calculating the value of a function, e.g. a function with only a handful of polynomial or trigonometric terms from a set of arguments is a relatively inexpensive computation. In fact, it is orders of magnitude simpler than the generation of even a single scenario path over several tens of time steps by Monte Carlo simulation. Accordingly, calculating the yield of a financial product at a large number of points (e.g. 5000 scenarios at 250 time steps) based on an approximation function obtained from a yield calculated, in an exacting, computationally intensive manner, at a proportionately small number of points (e.g. 50-100 scenarios at each time step) brings about considerable gain in terms of reducing the overall computational burden.

Although use of an approximation function may, in retrospect, seem straight forward based on common notions from the realm of everyday mathematics, this discovery was utterly unexpected for those skilled in the art of estimating the yield of financial products. As exemplified above via the travelling salesman problem, many discrete mathematical problems, including estimating the yield of many types of financial products, exhibit extremely complex behavior that the person skilled in the art does not expect to be approachable with conventional analytical methods.

The present disclosure teaches generation of a plurality of scenario paths in the multidimensional space by means of a stochastic process, each of the scenario paths comprising a respective third plurality of points in the multidimensional space. It moreover teaches choosing the second plurality of points by selecting, for each of the plurality of scenario paths, at least one of the respective third plurality of points, each of the selected points defining a respective one of the second plurality of points.

By definition, it is not possible to steer a stochastic process. Accordingly, if a path is generated by means of a stochastic process through a multidimensional space, the individual points of which multidimensional space are representative of possible scenarios, based on information, obtained from historical observations, indicative of the statistical likelihood of particular scenarios occurring, it cannot be ensured that that path will pass through (a predetermined neighborhood of) a particular point/scenario in that multidimensional space.

In implementing the teachings of the present disclosure, however, it is desirable to generate the aforementioned approximation function based on the value of the financial product at a plurality of well-selected points in the multidimensional space, i.e. at points that can be expected to yield an approximation function that is representative of the value of the financial product throughout a predefined region of the multidimensional space. If such a predefined region were to have the shape of a cube, for example, then the set of values used for generating the approximation function should include values calculated at points in the vicinity of each of the corners of the cube as well as values calculated at points in the vicinity of various points along the faces and in the central portion of the cube. In other words, the approximation function should be based on values each calculated at one of a variety of points well distributed throughout the entirety of the predetermined region of the multidimensional space.

To obtain such a well-distributed variety of points despite the random nature of the generated scenario paths, the present disclosure teaches selection of the aforementioned second plurality of points from points that lie along the generated scenario paths. In other words, the second plurality of points is selected from the points made available by the stochastic generation of scenario paths. If the generated scenario paths do not contain a sufficient number of points falling within a particular neighborhood considered necessary for the approximation function to properly represent the entirety of the predetermined region of the multidimensional space, more scenario paths can be generated until such a sufficient number is reached or until it becomes sufficiently apparent that that particular neighborhood considered need not be more densely populated with points in order for the approximation function to properly represent the entirety of the predetermined region of the multidimensional space. In latter case, the failure of the generated scenario paths to more densely populate the particular neighborhood with further points can be considered indicative of the statistical insignificance of that neighborhood to the overall results. Summarizing the above, the second plurality of points can be sampled, by any sampling technique as known in the art, from among the points/lines constituting the scenario paths as described in detail supra. Accordingly, the number of points constituting the second plurality of points can be easily scaled vis-à-vis the number of scenario paths as desired.

The present disclosure teaches receiving, for each respective one of the plurality of variables that constitute coordinates of the multidimensional space, a second set of data indicative of a risk-neutral probability distribution of said respective one of said plurality of variables. The present disclosure furthermore teaches receiving a set of coordinates indicative of a starting point in the multidimensional space. The present disclosure also teaches, with regard to the generating of the plurality of scenario paths, calculating, for each respective one of the scenario paths, a sequence of scenario points having coordinates in said multidimensional space that defines the respective one of the scenario paths by an iterative process that, starting from the aforementioned starting point as a first scenario point in said sequence, calculates each respective one of the coordinates of each respective next scenario point of said sequence by means of a Monte Carlo technique based on said respective one of the coordinates of a respective scenario point that immediately precedes the respective next scenario point in said sequence and the second set of data for a variable corresponding to said respective one of said coordinates.

In accordance with the present disclosure, scenario paths in the multidimensional space can be generated by a stochastic process. Although unexpected events occur on a daily basis in the real market, which justifies the use of random variables in simulating future market behavior, the market does follow particular rules, tendencies and expectations, albeit in a highly complex and interrelated manner. In order to allow these rules, tendencies and expectations to flow into the simulation of future market behavior, i.e. into the generation of scenario paths, the present disclosure teaches the use of a risk-neutral probability distribution with regard to each of the plurality of variables that constitute coordinates of the multidimensional space. Generally speaking, a risk-neutral probability distribution reflects the statistical likelihood of various future scenarios as measured with respect to any particular market factor. The risk-neutral probability distribution may be dependent on time and/or one or more other market factors.

Such a risk-neutral probability distribution can be obtained from observations of the market, i.e. can reflect real-world observations of market participant's behavior, and can be obtained from any point in time from the past to the present. For example, the interest rates at any given point in time for five-year, eight-year, ten-year and fifteen-year fixed-rate loans are indicative of the real-world market's expectations of how interest rates will develop in the future relative to that given point in time, particularly when such information is gathered from a variety of financial institutions. Since the market risks are presumed to be balanced between the participants of market transactions, such observations of actual market behavior are considered risk-neutral, i.e. are considered to inherently include a balanced/neutral assessment of the associated risks by the market participants. Properly collected and analyzed, as known in the art, such information can be used to produce a risk-neutral probability distribution with regard to any one particular market factor, e.g. interest rates or the price of oil, i.e. a function representative of the probability that that one particular market factor will change from a first value at a first point in time to a second value at a second point in time depending on zero or more other market factors at the first point in time.

The market is known to change over time. For example, many presumptions about future market behavior shared by a large percentage of the market participants on Sep. 10, 2001 were considered invalid just a few days later in view of the events of Sep. 11, 2001. The Lehmann Brothers bankruptcy in September 2008 similarly led to a sudden revision of market presumptions among market participants. Yet although most changes in market behavior are less sudden and considerably less drastic, the present disclosure teaches the use of risk-neutral probability distributions that are considered to be valid at a particular point in time in conjunction with estimations/simulations of future market behavior starting from that point in time with due regard for the market conditions at that point in time. In this manner, the present disclosure avoids distortions due to intermediate changes in market behavior with regard to one or more of the relevant market factors.

As stated above, the present disclosure teaches an iterative process for generating the respective scenario paths. Starting from a given starting point in the multidimensional space, e.g. the known market conditions on a given date in the past, a future scenario point is calculated by means of a Monte Carlo technique based on the second set of data, e.g. a risk-neutral probability distribution. For example, for each market factor/coordinate in the multidimensional space, a random number is generated. Based on a predetermined correlation between the possible random numbers and the risk-neutral probability distribution (which may be time dependent and/or dependent on one or more other market factors), a change in the value of the respective market factor, e.g. the price of oil, is simulated. The vector defined by the respective change in each of the market factors is added to the starting point to obtain the future scenario point. The process is then repeated starting from the calculated future scenario point to obtain the next future scenario point until a sufficiently long sequence of scenario points, i.e. a scenario path, has been generated. The technique described above may then be repeated until the desired number of scenario paths has been generated.

Since each scenario path is generated from a first point in time to a second, later point in time, path dependencies as described separately in the present disclosure, i.e. dependencies in the yield of a financial product on earlier events, receive due consideration.

The present disclosure teaches that the approximation function can have the aforementioned plurality of variables that constitute coordinates of the multidimensional space as input parameters. Similarly, the present disclosure teaches that the approximation function can have the plurality of variables and time as input parameters.

As discussed above, the purpose of the approximation function is to model, i.e. to approximate, a yield of the financial product in a particular region of the multidimensional space as obtained by (market) simulation, e.g. a yield calculated by simulating market behavior using Monte Carlo techniques. The yield of the financial product under various scenarios can then be estimated based on the approximation function without the computational overhead of stochastic simulation.

Since the yield of the financial product under particular market circumstances at one point in time may differ considerably from the yield of the financial product under identical market circumstances at another, distant point in time, a plurality of approximation functions may be used to estimate the yield of the product, i.e. to cover all relevant time steps. In other words, the relevant portion of the multidimensional space (strictly speaking, the multidimensional space is infinite in size; however, the yield of the financial product need only be simulated in a limited portion, i.e. relevant portion, of the multidimensional space) can be conceptually divided into a plurality of regions, e.g. non-overlapping regions, the simulated yield of the financial product in each region being approximated by a respective approximation function.

Whenever the multidimensional space has been divided into a plurality of non-overlapping regions and a corresponding plurality of approximation functions has been generated, each approximation function corresponding to a respective one of the regions, one must choose the correct, i.e. applicable/corresponding, approximation function when estimating a yield of the financial product for a particular scenario based on the approximation functions. Specifically, one must select the approximation function that models the yield of the financial product in the region encompassing the particular scenario.

If the multidimensional space has been divided into a plurality of regions, at least some of which overlap, a corresponding plurality of approximation functions has been generated, each approximation function corresponding to a respective one of the regions, and the scenario falls within more than one region, suitable measures as known in the art of approximation and/or statistics must be implemented for selecting from among the choice of possibly applicable approximation functions and/or for reconciling any numerical difference in the value of the various approximation functions for the particular scenario if more than one approximation function is used.

The present disclosure places no limitations on the manner in which the multidimensional space may be divided into regions. Division of the multidimensional space along one or more planes, each plane being perpendicular to any one of the coordinates axes, e.g. to the time axis, allows for a mathematically simple representation of the respective regions. Division of the multidimensional space perpendicular to the time axis is particularly simple when the yield of the financial product is only to be estimated at discrete points in time, e.g. at a predefined set of time steps. In such a case, each approximation function will be affiliated with a set of one or more time steps in a one-to-one relationship. For example, an approximation function may be generated for each time step at which the yield of the financial product is to be estimated. Similarly, an approximation function may be generated for groups of two, three or more time steps. In the former case, the time coordinate of any one of the aforementioned second plurality of points (at which a yield of the financial product is calculated in a computational expensive manner, e.g. based on a Monte Carlo simulation of market behavior) will be identical to the time coordinate of any other one of the second plurality of points. In other words, each of the second plurality of points will be located at the same time step. In latter case, each approximation function will not just be a function of the variable market factors, but also a function of time.

The present disclosure teaches generating an approximation function by calculating an approximation function that minimizes a value obtained by summing, for each respective one of said variables, the product of a weighting value and a sum, said sum being obtained by summing, for each respective one of said second plurality of points, the square of the difference between said approximation function and said calculated yield at said respective one of said second plurality of points.

Similarly, the present disclosure teaches generating an approximation function by calculating an approximation function that minimizes a value obtained by summing, for each respective one of said variables and time, the product of a weighting value and a sum, said sum being obtained by summing, for each respective one of said second plurality of points, the square of the difference between said approximation function and said calculated yield at said respective one of said second plurality of points.

As discussed supra, the present disclosure teaches generation of an approximation function having the aforementioned plurality of variables (and optionally time) as input parameters, the approximation function approximating, for each respective one of the aforementioned second plurality of points (at which a yield of the financial product is calculated in a computational expensive manner, e.g. by means of a Monte Carlo simulation), the calculated yield at the respective one of the second plurality of points. Since the approximation function may approximate a large number of values for a particular point in the multidimensional space, the approximation function may be termed a “smoothing function.”

The present disclosure places no limitations on the manner in which the approximation function is generated. An exemplary technique is the so-called “least squares” technique in which, for each data point to be approximated, the difference between the known value at that point and the value of the approximation function at that point is squared and added to a total sum; the goal being to find the approximation function that minimizes that total sum. Since several variables are involved, the present disclosure teaches weighting the total sum obtained, as described above, for each variable and summing the weighted totals; the goal being to find the approximation function that minimizes the summed weighted totals. Other techniques for generating the approximation function include non-parametric regression and kernel smoothing.

The generation of an approximation function that approximates a plurality of given data points in a multidimensional space is well known in the art of mathematics and is often designated as “curve fitting.” Accordingly, reference is made to the relevant literature as regards the details of and alternative techniques for generating the approximation function. Particular reference is made to the literature cited in the bibliography at the end of this specification.

While curve-fitting techniques are well known and in widespread use, it is likewise well known that the accuracy with which approximating functions obtained by curve-fitting techniques can approximate the given data does not necessarily reflect the accuracy with which an approximating function approximates the underlying function/phenomenon that gave rise to the given data. Accordingly, the popularity of curve-fitting techniques, e.g. in the field of statistics, does not lessen the contribution of this aspect of the present disclosure to the prior art.

The present disclosure teaches an embodiment wherein the first plurality of points comprises at least 5000 points, the second plurality of points comprises at least 8000 points and the plurality of variables comprises at least 5 variables. These numbers represent a typical implementation of the present disclosure. Often, a yield of a financial product is to be calculated under roughly 5000 different scenarios per time step. Employing prior art techniques, the yield at each of these scenarios would need to be simulated several thousand times using a computationally expensive Monte Carlo technique. Accordingly, a total of several million computationally expensive simulations in five dimensions (on account of the exemplary five variables) would be required per time step. Contrary thereto, the present disclosure teaches the simulation of a relatively small number of (e.g. five-dimensional) scenarios per time step, e.g. on the order of five to ten thousand scenarios, e.g. roughly 8000 scenarios. As described above, the scenarios can be obtained by generated and sampling a desired number of scenario paths, e.g. on the order of ten thousand scenario paths. Having regard for the yield calculated at each of these e.g. 8000 scenarios, a smoothing function would be generated in the five-dimensional space and the yield would be calculated at the 5000 scenarios based on the smoothing function without the need for further, computationally expensive simulations.

An interesting aspect of the present disclosure is that data defining one or more of the scenario paths with respect to one or more of the coordinates of the multidimensional space can be stored for use in a later simulation. For example, if a large number of scenario paths are generated with respect to a market factor whose probability distribution is independent of all other market factors or whose probability distribution is dependent only on market factors that will reappear in the later simulation, then the simulation data (e.g. vector data as described supra) with respect to that market factor need not be simulated again. Instead, such data can be reused for a further reduction in calculation expense.

As is apparent from the above summary, the techniques disclosed in the present disclosure do not provide a more accurate estimation of a yield of a financial product than prior art techniques. Instead, the present disclosure provides an apparatus, a method and a computer program product that place lesser demands on the computational hardware than the prior art. This not only reduces the amount of hardware necessary, but also reduces power consumption and maintenance costs.

It is moreover apparent from the above summary that the present disclosure does not provide a general-purpose algorithm for solving a class of mathematical problems, but instead addresses the specific, real-world problem of transforming data that reflects the terms of a financial product into price estimates for that product in the future, i.e. into data required e.g. by corporate management and regulatory authorities for determining the volume of low-risk assets that must be held by a financial institution to suitably counterbalance the risk imposed by investments in the financial product, the transformation being effected with due regard for the statistical likelihood of various future scenarios occurring as determined from real-world observations of market participants' behavior.

### BRIEF DESCRIPTION OF THE DRAWINGS

FIG. 1 shows four simulated scenario paths in accordance with the teachings of the present disclosure.

FIG. 2 shows a normal distribution function.

FIG. 3 shows an alternative representation of the normal distribution function shown in FIG. 2.

FIG. 4 shows an approximation function in accordance with the teachings of the present disclosure.

FIG. 5A schematically shows a fifth exemplary embodiment of an apparatus for estimating a yield of a financial product in accordance with the present disclosure.

FIG. 5B schematically shows a modification of the embodiment of FIG. 5A.

### DETAILED DESCRIPTION OF EXEMPLARY EMBODIMENTS

Exemplary embodiments will be described hereinafter with reference to the Figures.

### First Exemplary Embodiment

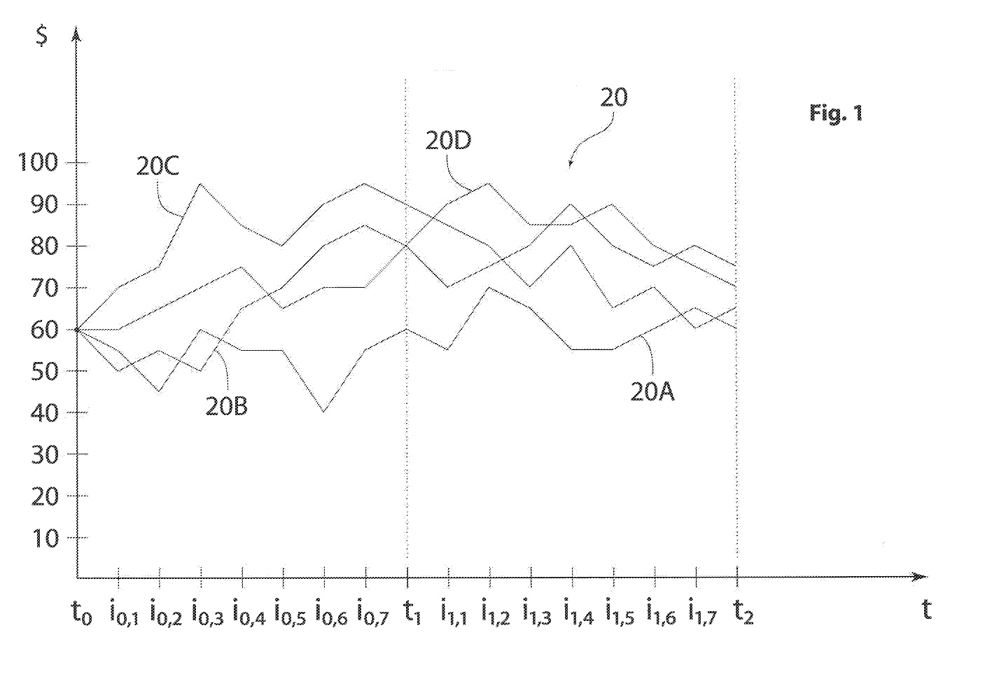

FIG. 1 shows a plurality of scenario paths 20 including exemplary scenario paths 20A, 20B, 20C and 20D simulating the price of oil between a time step t₀ and a time step t₂. In the illustrated example, each of the scenario paths indicates a possible future price of oil starting from a known, e.g. current, price of $60. Each of the scenario paths is generated by a stochastic process to reflect, i.e. simulate, the uncertainty of market behavior. Since each scenario path is generated independently, the individual scenario paths may show potential market tendencies that are not indicated by others of the plurality of scenario paths. For example, scenario path 20A shows a fall in the price of oil to about $40 shortly before time t₁ whereas scenario path 20B shows a rise in the price of oil to roughly $80 at the same point in time. Similarly, since each scenario path is generated independently, any scenario path may cross any other scenario path. For example, scenario path 20D crosses scenario paths 20B and 20C. Scenario path 20A crosses scenario paths 20B and 20C.

As discussed above, a typical simulation of the yield of a financial product in accordance with the teachings of the present disclosure will comprise on the order of several hundred to several thousand scenario paths, i.e. many more than the four exemplary scenario paths shown. As likewise discussed above, the individual scenario paths are typically calculated at time intervals shorter than the time steps of interest, i.e. at several intermediate time steps. In the illustrated example, the course of each scenario is calculated not only at each respective time step, but also at seven intermediate time steps between adjacent time steps. Typically, the course of each scenario will be calculated, in temporally sequential order, at on the order of one hundred intermediate time steps from one time step to the next. In FIG. 1, the seven intermediate time steps between time steps t₁ and t₂ are designated i_{0,1} to i_{0,7} and the seven intermediate time steps between time steps t₁ and t₂ are designated i_{1,1} to i_{1,7}. Accordingly, each time step is divided into eight intervals in FIG. 1.

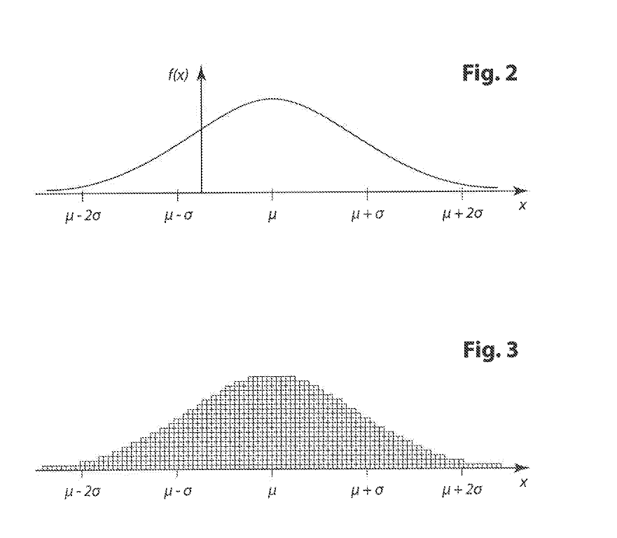

FIG. 2 shows a normal distribution function ƒ(x) with respect to a variable x. Repeated measurements of a physical quantity are known to typically yield a normal distribution. Accordingly, a risk-neutral probability distribution typically has the form or is given in the form of a normal distribution. In latter case, the risk-neutral probability distribution is defined by the following equation for a normal distribution using the expected mean value μ and the standard deviation σ of the expected value from the expected mean value as constants. Here, the term “expected” means market expectations as measured by observation and evaluation of actual market transactions as discussed supra. As discussed above, such expectations will typically be a function of time (for example, the price of oil expected for tomorrow differs significantly from the price of oil expected for the year 2050) and may be dependent on one or more other market factors.

$$f ( x ) = \frac{1}{\sqrt{2 π} σ} {e}^{- {( x - μ )}^{2} / ( 2 {σ}^{2} )}$$

A normal distribution function ƒ(x) is a probability function, i.e. is indicative of the probability that a “measured” parameter (e.g. the expected price of oil at a particular time in the future) will have a particular value, the variable x. A normal distribution function is symmetric with respect to the mean value μ of the “measured” parameter and has its highest value at that point. In other words, the most probable value of the “measured” parameter is its mean value. As in the above equation, FIG. 2 uses the Greek letter σ to signify the standard deviation of the “measured” parameter from the mean value of the “measured” parameter as known in the art of statistics.

The integral (i.e. sum in layman's terms) of the area under the curve defined by a normal distribution function ƒ(x) between minus infinity and plus infinity is exactly one. In other words, a normal distribution function ƒ(x) specifies the probability of the “measured” parameter in such a way that the likelihood of the “measured” parameter lying somewhere between minus infinity and plus infinity is exactly 100% as one would expect.

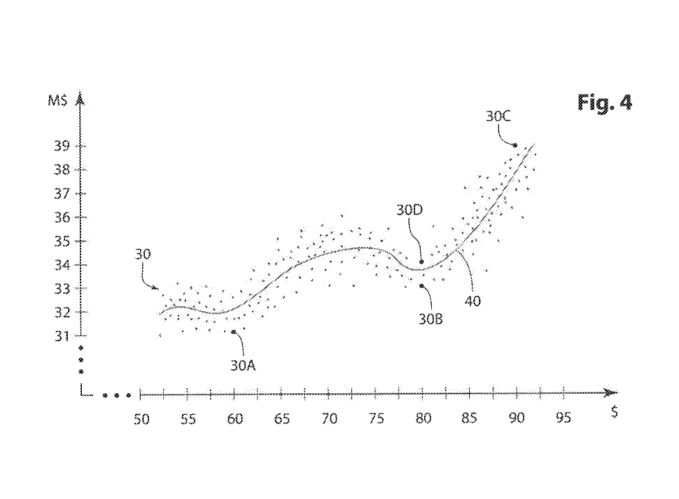

As schematically shown in FIG. 3, the aforementioned nature of normal distribution functions can be exploited to easily convert a random number into a correspondingly probable value of a “measured” parameter represented by a normal distribution function ƒ(x). For example, if a “measured” parameter is to be simulated in a stochastic process by a random number between 1 and 1000, the area under a normal distribution function ƒ(x) representing the “measured” parameter can be partitioned into one thousand squares of equal size, each of the squares being associated with one and only one of the random numbers. For each random number that is generated, the “measured” parameter then is assumed to have a value corresponding to the x-coordinate of the center of the square associated with the respective random number. Naturally, other techniques for converting a random number into a correspondingly likely value are equally applicable.

In the example illustrated in FIGS. 1-4, a generated random number will be converted by the technique discussed above with reference to FIG. 3 into a value that simulates the course of a respective scenario path at a particular point in time. Presuming, for example, that the calculated risk-neutral probability distribution is considered valid for all time steps between t₀ and t₁, a first random number corresponding to a value, i.e. an oil price, of $55 is generated for intermediate time step i_{0,1} of scenario path 20A. Then a second random number corresponding to a value of $45 is generated for intermediate time step i_{0,2} of scenario path 20A, etc. Such a sequence of random numbers stipulates the course of each scenario path over time. A different risk-neutral probability distribution may then be used to generate the scenario paths between time steps t₁ and t₂.

As is evident from FIG. 3, the majority of the simulated values are likely to lie close to the mean value μ of the “measured” parameter. Very few of the simulated values are likely to be larger than μ+2σ or smaller than μ−2σ. This tendency of a simulated parameter to adopt a value close to a “measured” mean value explains why none of the exemplary scenario paths 20A-20D shown in FIG. 1 predicts a future oil price of $5 or $200. While such values may crop up, despite a mean expected value of e.g. $70 and a standard deviation (of the expected value from the mean value) of e.g. $20, in a few scenario paths of a group comprising many thousands of simulated scenario paths, such values remain statistically unlikely.

Since the value of the financial product at time steps t₁ and t₂ is of interest, the yield of the financial product will be determined for each scenario path at time steps t₁ and t₂ based on the terms of the financial product and the relevant market parameters as stipulated by the respective scenario path at the respective time step and, as the case may be, in the past. In the illustrated example, the yield of the financial product is presumed to be dependent solely on the price of oil and on possible exercise of options included in the terms of the financial product.

In the illustrated example, the buyer is presumed to have the option of purchasing anywhere up to a fixed maximum amount of oil at a predetermined price, e.g. $70, between time steps t₀ and t₁. In the case of scenario path 20C, the buyer's behavior is simulated, again using a stochastic process based on actually observed behavior of market participants, as exercising the aforementioned option to the maximum amount at intermediate time step i_{0,7}. Similarly, in the case of scenario path 20B, buyer behavior is simulated as exercising the aforementioned option to half of the maximum amount at intermediate time step i_{0,5}. Accordingly, although scenario paths 20B and 20D have the same value at time step t₁, the yield of the financial product in accordance with scenario path 20B at time step t₁ is simulated as being different from, i.e. less than, the yield of the financial product in accordance with scenario path 20D at time step t₁. Moreover, the yield of the financial product in accordance with scenario path 20C at time step t₁ is larger than one might expect from the expected price of oil at time step t₁.

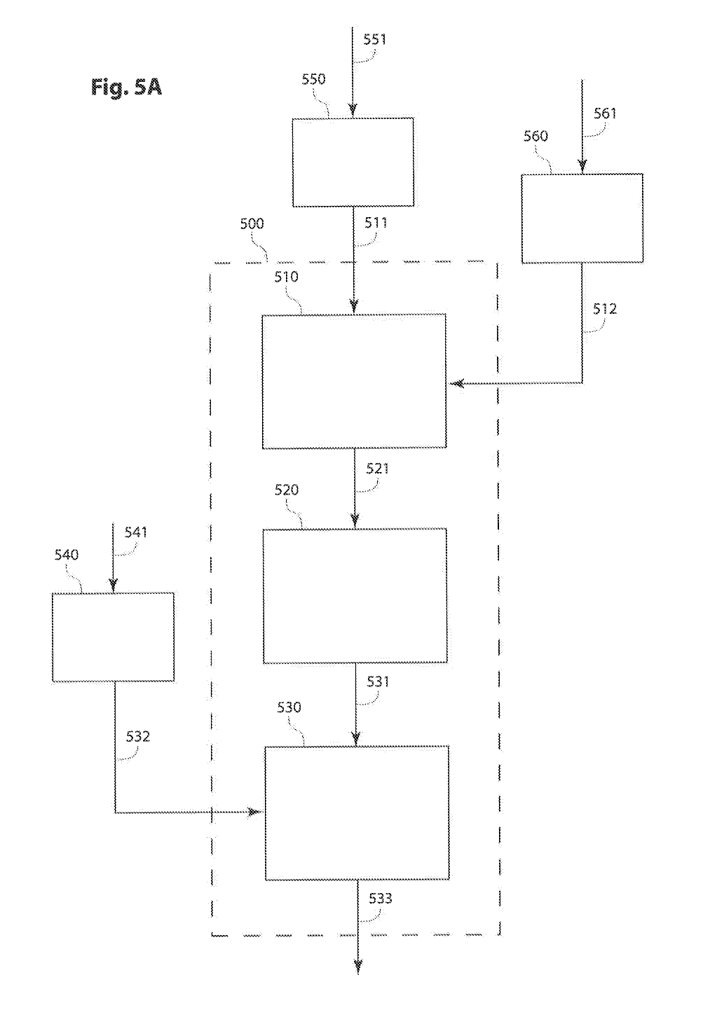

FIG. 4 shows an approximation function 40 in accordance with the teachings of the present disclosure. Moreover, FIG. 4 shows the yield of the financial product with respect to the price of oil for a plurality of scenarios 30 at time step t₁ including the scenarios 30A, 30B, 30C and 30D corresponding to the scenarios simulated by scenario paths 20A-20D, respectively, at time step t₁. As discussed above, the yield for scenario 30B is less than the yield for scenario 30D although both scenarios expect an oil price of $80 at time step t₁. Approximation function 40 approximates the plurality of scenarios, i.e. reduces the plurality of scenarios e.g. to a single function. As discussed above, the approximation function 40 can be obtained by the least squares method. Once generated, the approximation function 40 can be used to estimate the yield of the financial product in a cost and energy-efficient manner.

In the example of FIG. 4, the approximation function is one-dimensional, i.e. simulates the yield of the financial product with regard to a single parameter, in this case the price of oil. Typically, the simulation exemplified by FIG. 1 will be carried out in a plurality of dimensions, each dimension reflecting possible scenarios with respect to a respective market factor. The approximation function will then be a multi-dimensional function having a corresponding number of parameters. In a two-dimensional case, one can imagine the approximation function as a mountainous landscape, one market factor stipulating the latitude, the other market factor stipulating the longitude of the landscape. The altitude of the mountainous landscape at a particular latitude and longitude then reflects the approximated, simulated yield of the financial product.

While various embodiments of the present invention have been disclosed and described in detail herein, it will be apparent to those skilled in the art that various changes may be made to the configuration, operation and form of the invention without departing from the spirit and scope thereof. In this respect, it is noted that the respective features of the invention, even those disclosed solely in combination with other features of the invention, may be combined in any configuration excepting those readily apparent to the person skilled in the art as nonsensical. Likewise, use of the singular and plural is solely for the sake of illustration and is not to be interpreted as limiting. Except where the contrary is explicitly noted, the plural may be replaced by the singular and vice-versa.

### Second Exemplary Embodiment

The algorithm in accordance with a second embodiment of the present disclosure for the pricing of a financial product in multiple scenarios comprises 7 separate steps, steps 3 and 4 of which are optional:
1. Importing scenarios P: [symbol] ×Ωₚ→ [symbol] at which the product prices shall be computed. Each element of Ωₚ is associated with a plurality of s risk-factors drawn at each time step in [symbol] .
2. Generation of pricing scenario Q: [symbol] ×Ω_{q}→ [symbol] for the product price estimation. Q is computed by sampling of a stochastic process. Each element of Ω_{q} is associated with a plurality of s risk-factors drawn at each time step in [symbol]
3. Compute path-dependent product specific variables Aₚ: [symbol] ×Ωₚ→ [symbol] corresponding to the scenarios in step 1. These path-dependent variables include for example fixings or exercises performed by the product's issuer or the holder.
4. For each scenario of step 2: Computation of product specific variables A_{q}: [symbol] ×Ω_{q}→ [symbol] corresponding to the scenario. These path-dependent variables include fixings and optimal exercises.
5. Computation of the product's remaining discounted cash-flows V_{q}: [symbol] ×Ω_{q}. At each scenario and each time-step in the scenarios of step 2 all remaining cash-flows are scenario-wise discounted and summed.
6. For each scenario of step 1: Computation of a price estimate function F: [symbol] × [symbol] × [symbol] → [symbol] F is obtained by a smoothing procedure on the scenarios of step 2 and the path-dependent variables of step 4.
7. Computation of the product prices for each scenario ωₚεΩₚ and each time step tₚε [symbol] from step 1. This evaluation is performed efficiently as Vₚ(tₚ,ωₚ)=F(tₚ,P(tₚ,ωₚ),Aₚ(tₚ,ωₚ)).

The above steps are described in further detail hereinbelow.

In step 1, the scenarios consist of a realization of values for each risk factor which has to be taken into account. Typical risk factors for a structured financial product are: prices of underlyings, implied volatilities and long-term as well as short term interest-rates. In the following, the scenarios from step 1 are referred to as physical scenarios and all associated variables are denoted by an index p.

The origin of the scenarios in step 1 can be manifold: historical simulation, shifting of current risk factor values and Monte Carlo simulation are possible choices. The scenarios can consist of a single time step or multiple time steps. The particular choice depends on the specific result one expects from the analysis. A multi-time step Monte Carlo simulation might be useful for the computation of risk-measures such as Value at Risk while a single time step with a shift of the risk factors is useful for stress testing and estimating the risk contribution of single instruments.

The physical scenarios are denoted by P: [symbol] ×Ωₚ→ [symbol] whereas Ωₚ={1, . . . , nₚ} is a numbering for the scenarios and [symbol] ={tₚ⁰, . . . , tₚ^{T}^{ₚ}} is the set of time steps. At each scenario and each time step, an s-tuple of risk-factors is given.

The scenarios of step 2 are used for the product valuation itself and it is useful to generate so-called risk-neutral scenarios (also known as pricing scenarios) for this task as defined by the option pricing theory. All associated variables are denoted by an index q. Examples for such scenarios are e.g. geometric Brownian motion where the drift is set to the risk-free rate of interest and constant volatility as well as geometric Brownian motion with Heston volatility [Heston 1993].

The scenarios of step 2 are denoted by Q: [symbol] ×Ω_{q}→ [symbol] whereas Ω_{q}={1, . . . , n_{q}} is a numbering for the scenarios and [symbol] ={t_{q}⁰, . . . , t_{q}^{T}^{_{q}}} is the set of time steps. At each scenario and each time step, an s-tuple of risk-factors is sampled from a stochastic model. Additionally, there is a mapping I:Ω_{q}→ [symbol] For each scenario ω_{q}εΩ_{q}, the pricing scenario path Q(t,ω_{q}), tε [symbol] is called active for t≧I(ω_{q}).

The set [symbol] contains all relevant time steps (fixings) for the evaluation of the financial product. Furthermore, the algorithm works well when relevant physical scenario time steps are contained as well, i.e. [symbol] ⊃{tₚ⁰, tₚ¹, . . . , tₚ^{k}}, where t_{q}^{T}^{_{q}} is the maturity time of the financial product.

For step 2, an implementation to create the simulations with one or more of the following properties can be beneficial:
a. the pricing scenario paths start at the same time and the same value as the physical scenarios, i.e. I(ω_{q})=tₚ⁰ and P(tₚ⁰,ωₚ)=Q(tₚ⁰,ω_{q}) ∀ωₚεΩₚ, ∀ω_{q}εΩ_{q},
b. the pricing scenario paths start at the same time and similar value as the physical scenarios, i.e. I(ω_{q})=tₚ⁰ and P(tₚ⁰,ωₚ)≈Q(tₚ⁰,ω_{q}) ∀ωₚεΩₚ, ∀ω_{q}εΩ_{q},
c. each pricing scenario path ω_{q}εΩ_{q} forks a physical scenario at some time t_{ω}ε [symbol] ∩ [symbol] i.e. I(ω_{q})=t_{ω} and ∃ωₚεΩₚ:P(t_{ω},ωₚ)=Q(t_{ω},ω_{q})
d. each pricing scenario path ω_{q}εΩ_{q} forks at some time t_{ω}ε [symbol] ∩Tₚ in the proximity of a physical scenario, i.e. I(ω_{q})=t_{ω} and ∃ωₚεΩₚ:P(t_{ω},ωₚ)≈Q(t_{ω},ω_{q}).

In optional step 3, for time step tₚε [symbol] and each scenario ωₚεΩₚ the path dependent values Aₚ: [symbol] ×Ωₚ→ [symbol] are computed. These sₐ-tuples together with the current risk factor values P(tₚ,ωₚ) must be sufficient to price the financial product at time step tₚ. The values at time tₚ⁰ are given by an initialization function ƒ₀, i.e. Aₚ(tₚ⁰,ωₚ)=ƒ₀(tₚ⁰, P(tₚ⁰,ωₚ)). These values are part of the product's structural features and could be imported from a database. The successive values at times tₚⁱ>tₚ⁰ are computed from an update formula ƒₚ, i.e. Aₚ(tₚⁱ,ωₚ)=ƒₚ(tₚⁱ,Aₚ(tₚⁱ⁻¹,ωₚ),P(tₚⁱ,ωₚ)) for i=1, . . . , Tₚ.

Examples or path dependent variables Aₚ are
information about knock-out of Barrier options,
the current average of Asian options,
exercise, conversion and calls of the financial product based on e.g. the investor's utility,
measurable characteristic values re the stochastic model in step 2,
portfolio weights of dynamic strategies, e.g. Simulation-Based Hedging (Grau 2008),
previous values of risk factors.

In optional step 4, similar to step 3, the path-dependent variables are given by A_{q}: [symbol] ×Ω_{q}→ [symbol] for time step t_{q}ε [symbol] and each pricing scenario ω_{q}εΩ_{q}. These sₐ.

tuples together with the current risk factor values P(t_{q},ω_{q}) must be sufficient to price the financial product at time step t_{q}. The values at time I(ω_{q}) are initialized with appropriate values.

For an implementation to compute the initial path-dependent variables A_{q} it can be beneficial to use one of the following methods:
a. If there exists at least one physical path that matches a pricing scenario path at its first active time step then one can use a physical path-dependent state as initial state, i.e, ∃ωₚεΩₚ:P(t_{ω},ωₚ)=Q(t_{ω},ω_{q}), I(ω_{q})=t_{ω} then use A_{q}(t_{ω},ω_{q})=Aₚ(t_{ω},ωₚ).
b. Alternatively, one can choose a physical path ωₚ which is similar to the pricing scenario paths ω_{q} at time t_{ω}=I(ω_{q}). Then, one can initialize the path-dependent state A_{q}(t_{ω},ω_{q}) to be equal or similar to Aₚ(t_{ω},ωₚ), i.e. ∃ωₚεΩₚ:P(t_{ω},ωₚ)≈Q(t_{ω},ω_{q}), I(ω_{q})=t_{ω} then use A_{q}(t_{ω},ω_{q})≈Aₚ(t_{ω},ωₚ) where A_{q} is an artificial realization of the path-dependent variables. Note that the new values should be consistent with the structure of the financial product and possible path histories.
c. For each pricing scenario path ω_{q}, one can initialize the path-dependent variables from a synthetic path R_{ω}: [symbol] → [symbol] with {tₚ⁰,t_{ω}}⊂ [symbol] The synthetic path must have the same value as the scenario path at time t_{ω}, i.e. R_{ω}(t_{ω})=Q(t_{ω},ω_{q}). Equivalent to the update formula in step 3, one computes A_{q}(t_{ω},ω_{q})=Aᵣ(t_{ω}) through an iterative process.

In step 5, the product's remaining cash-flows are discounted to a cash value V_{q}: [symbol] ×Ω_{q}. Consider a discount factor d: [symbol] × [symbol] ×Ω_{q}→ [symbol] For each pricing scenario ω_{q}εΩ_{q} returns the function d(tₚ,t_{q},ω_{q}) the discount factor from time t_{q} to time tₚ. This function is constructed knowing the full history of the path ω_{q}.

In each pricing scenario the product-specific cash flows are given by C:Ω_{q}× [symbol] → [symbol] i.e. the payoff in scenario ω_{q} at time t_{q} is C(ω_{q},t_{q}). The cumulated and discounted remaining cash flows V are computed by

$${V}_{q} ( {t}_{q} , {ω}_{q} ) = {\sum }_{{ }_{\begin{matrix}t ∈ {τ}_{q} \\ t \geq {t}_{q}\end{matrix}}} d ( {t}_{p}^{0} , t , {ω}_{q} ) C ( t , {ω}_{q} ) .$$

A central aspect is step 6 where the product prices in each physical scenario and each physical time-step are computed using the pricing scenario paths from step 2. Consider subsets [symbol] ⊂ [symbol] and \tilde{Ω}⊂Ω_{q}. The set M(\tilde{T},\tilde{Ω}) is defined as a set of (X, Y)-pairs that can be used for smoothing algorithms,

$$M ( \tilde{𝕋} , \tilde{Ω} ) = \{ ( {X}_{1} , {X}_{2} , Y ) : X = ( t , Q ( t , ω ) , {A}_{q} ( t , ω ) ) , Y = {V}_{q} ( t , ω ) , t ∈ \tilde{𝕋} , t \leq I ( ω ) , ω ∈ \tilde{Ω} \} .$$

The operator Ψ computes a smoothing on a set of (X, Y)-pairs which results in a function that maps risk factor tuples and path-dependent state tuples onto product prices, i.e

Ψ:( [symbol] × [symbol] )ⁿ→( [symbol] → [symbol] ).

It is useful that Ψ creates an estimator for the conditional expected values E(X|Y). Useful smoothing algorithms for Ψ are:
a. Non-parametric regression sets the result function as a linear combination of basis functions bᵢ, i.e. Ψ(M)=Σᵢ₌₁ⁿ^{_{b}}cᵢbᵢ. The coefficients cᵢ are determined by minimizing the quadratic error

$$( {c}_{1} , … , {c}_{{n}_{ɛ}} ) = arg min {\sum }_{( X , Y ) ∈ M} {( Ψ ( M ) ( X ) - Y )}^{2} .$$

b. Kernel smoothing is defined by a sum of weighted Y values, i.e.

$$Ψ ( M ) ( x ) = \frac{1}{\vert M \vert} {\sum }_{i} {ω}_{i} ( x ) {Y}_{i} ,$$

with a weight function ωᵢ(x) constructed from the location of the X values.

Further information about the smoothing algorithms mentioned here and other smoothing algorithms can be found at Härdle 2001. An interesting approach to non-parametric regression is presented by Garcke et al. 2001. Sometimes it is useful to select a subset of M before performing one of the above smoothing algorithms. Furthermore, it also can be useful to use semi-parametric regression, thin-plate splines or b-spline basis functions.

The function F: [symbol] × [symbol] × [symbol] → [symbol] allows the efficient evaluation of prices in all time-steps and all physical scenarios. It can be constructed in one of the following ways:
a. The smoothing is done on all data at once, i.e. F(t,Q,A)=Ψ(M( [symbol] ,Ω_{q}))(t,Q,A).
b. The smoothing is done on each time step individually, i.e. F(t,Q,A)=Ψ(M({t},Ω_{q}))(t,Q,A). With only a single time step per smoothing, regression methods benefit from decreasing the dimensionality by 1.
c. Other partitions of [symbol] and Ωₚ might be useful to cut the large smoothing problem into a set of smaller smoothing problem.

Finally, the product price is computed in Step 7. For each scenario ωₚεΩₚ and each time step tₚε [symbol] , the evaluation is performed efficiently as Vₚ(tₚ,ωₚ)=F(tₚ,P(tₚ,ωₚ),Aₚ(tₚ,ωₚ)). The price estimates Vₚ are computed within the stochastic model generating the pricing scenario paths in step 2. Hence, this algorithm is an efficient way to compute product prices in physical scenarios based on an arbitrary stochastic model.

It can be useful that the pricing scenario paths Q and the associated path-dependent variables A_{q} are made persistent such that later computations of the smoothing function can be performed efficiently. Another possibility for an improvement is to make the smoothing function F persistent itself such that later computations of product prices for new risk factor tuples P can be performed efficiently. Then, it can be useful to refine the smoothing function F iteratively by computing additional pricing scenario paths on demand, based on an error estimate for the price generated at the new risk factor tuples.

### Third Exemplary Embodiment

The following section describes a detailed example of the computation of financial product prices by Monte Carlo simulation in several physical scenarios using the techniques of the present disclosure. In order to be concise and reproducible, the example is restricted to 3 physical and 5 risk-neutral scenarios. It is easy to extend this small example to a realistic setting by adding more scenarios and additional risk-factors.

Consider a European call option with a strike price of 100 and a maturity time of 3 years. The physical scenarios Ωₚ={1, 2, 3} and the time-steps [symbol] ={t₀, t₁, t₂} are used. Consider further the possible values of the physical scenarios P for a stock price, which serves as the underlying of the European option:

| | tₚ | | |
|---|---|---|---|
| P(tₚ, ωₚ) | t₀ | t₁ | t₂ |

| | | | | |
|---|---|---|---|---|
| ωₚ | 1 | 100 | 110 | 120 |
| | 2 | 100 | 100 | 100 |
| | 3 | 100 | 90 | 80 |

In each of these scenarios at each time-step the European option value shall be estimated by Monte Carlo simulation. The 6 option prices for time steps t₁ and t₂ shall be computed as fast and accurate as possible. Prior art techniques would perform 6 completely separate pricing procedures. The techniques of the present disclosure only require a single scenario set Q of risk-neutral pricing scenario paths Ω_{q}={1, 2, 3, 4, 5} at time steps [symbol] ={t₀, t₁, t₃} starting at time t₀, i.e. I(1)=I(2)=I(3)=I(4)=I(5)=t₀:

| | | t_{q} | | | |
|---|---|---|---|---|---|
| Q(t_{q}, ω_{q}) | | t₀ | t₁ | t₂ | t₃ |
| ω_{q} | 1 | 100.0000 | 211.7568 | 214.8651 | 106.2542 |
| | 2 | 100.0000 | 112.9350 | 70.6952 | 70.8322 |
| | 3 | 100.0000 | 154.1112 | 193.8189 | 221.6990 |
| | 4 | 100.0000 | 90.2616 | 155.3396 | 121.7245 |
| | 5 | 100.0000 | 174.4274 | 199.2726 | 258.4810 |

These risk-neutral scenarios are created using a stochastic model with geometric Brownian motion for Q but other (risk-neutral) simulations are suitable, too. Now the option's payoff value is computed at time t₃, C(t₃,ω_{q})=max(Q(t₃,ω_{q})−100,0), which is equal to V_{q}(t,ω_{q}) for all tε [symbol] because there is only a single cash-flow at maturity time and the risk-free rate of interest is zero (d(t₀,t,ω_{q})=1). Note that the option has no path-dependency, thus A is empty and sₐ=0. The values are:

| ω_{q} | C(t₃, ω_{q}) | V_{q}(t, ω_{q}) |
|---|---|---|
| 1 | 6.2542 | 6.2542 |
| 2 | 0.0000 | 0.0000 |
| 3 | 121.6990 | 121.6990 |
| 4 | 21.7245 | 21.7245 |
| 5 | 158.4810 | 158.4810 |

In order to obtain estimates of the option prices at time t₂, a set M({t₁},Ω_{q}) is created:

| | | |
|---|---|---|
| M({t₁}, Ω_{q}) | X = (t, Q, A) | Y |

| | |
|---|---|
| (t₁, 211.7568) | 6.2542 |
| (t₁, 112.9350) | 0.0000 |
| (t₁, 154.1112) | 121.6990 |
| (t₁, 90.2616) | 21.7245 |
| (t₁, 174.4274) | 158.4810 |

Next, the smoothing operation Ψ has to be applied to the data set M. Since option pricing is performed in a Black-Scholes setting, option prices are given by conditional expected values E(Y|X). Thus, estimates for the expected values are also estimates for the option price. Here, a simple nonparametric regression is used in X₂. X₁ is constant and will not be considered. The smoothing functions is

Ψ(M)=c₁+c₂·X₂+c₃·(X₂)²

with c₁, c₂ and c₃ are coefficients of polynomial basis functions. In a realistic setting, other smoothing methods or other basis functions are useful, too. Now, the coefficients are computed as a solution to the minimization of

$$( {c}_{1} , {c}_{2} , {c}_{3} ) = arg min ( {\sum }_{ω = 1}^{5} {( {Y}_{ω} - Ψ ( M ) ( {X}_{ω} ) )}^{2} )$$

for all risk-neutral scenarios ω=1 . . . 5. This least-squares minimization is a standard problem and can be solved by normal equations using the matrix

$${B}_{q} = ( \begin{matrix}1 & {X}_{1 , 2} & {( {X}_{1 , 2} )}^{2} \\ ⋮ & ⋮ & ⋮ \\ 1 & {X}_{5 , 2} & {( {X}_{5 , 2} )}^{2}\end{matrix} ) , \\ {B}_{q} ( {t}_{1} ) = ( \begin{matrix}1 & 211.7568 & 44840.9334 \\ 1 & 112.9350 & 12754.3143 \\ 1 & 154.1112 & 23750.2631 \\ 1 & 90.2616 & 8147.1538 \\ 1 & 174.4274 & 30424.9189\end{matrix} ) .$$

Now, the coefficients c₁, c₂ and c₃ can be obtained by

c=(B_{q}^{T}B_{q})⁻¹·B^{T}V

which leads to
c₁=−651.7604
c₂=9.9033
c₃=−0.0317

In order to obtain the approximations for the physical asset paths, the corresponding matrix needs to be set up with one row for each physical scenario

$${B}_{p} = ( \begin{matrix}1 & P ( {t}_{1} , 1 ) & {( P ( {t}_{1} , 1 ) )}^{2} \\ 1 & P ( {t}_{1} , 2 ) & {( P ( {t}_{1} , 2 ) )}^{2} \\ 1 & P ( {t}_{1} , 3 ) & {( P ( {t}_{1} , 3 ) )}^{2}\end{matrix} ) ,$$

This leads to

$${B}_{p} ( {t}_{1} ) = ( \begin{matrix}1 & 110 & 12100 \\ 1 & 100 & 10000 \\ 1 & 90 & 8100\end{matrix} )$$

and the approximations of the smoothing function F=Ψ(M) are obtained for the first time step, by

$$( \begin{matrix}F ( {t}_{1} , P ( {t}_{1} , 1 ) ) \\ F ( {t}_{1} , P ( {t}_{1} , 2 ) ) \\ F ( {t}_{1} , P ( {t}_{1} , 3 ) )\end{matrix} ) = {B}_{p} \cdot c .$$

The result is the option price estimation Vₚ(t₁,ωₚ) for each scenario ωₚεΩₚ.

| ωₚ | Vₚ(t₁, ωₚ) |
|---|---|
| 1 | 54.57 |
| 2 | 22.01 |
| 3 | −16.87 |

This is a very efficient way of estimating option prices. Note that 5 scenarios and 3 basis functions are not sufficient for precise estimates. This simplified example results in a negative price estimate for physical scenario 3. However, more paths and more basis functions, carefully chosen, lead to accurate results.

Now, the same scenarios can be used to obtain the prices at time t₂ of the physical scenarios. In order to obtain estimates of the option prices at time t₂, a set M({t₂},Ω_{q}) is created:

| | | |
|---|---|---|
| M({t₂}, Ω_{q}) | X = (t, Q, A) | Y |

| | |
|---|---|
| (t₂, 214.8651) | 6.2542 |
| (t₂, 70.6952) | 0.0000 |
| (t₂, 193.8189) | 121.6990 |
| (t₂, 155.3396) | 21.7245 |
| (t₂, 199.2726) | 158.4810 |

Again, a matrix B_{q} is constructed for the regression

$${B}_{q} ( {t}_{2} ) = ( \begin{matrix}1 & 214.8651 & 46167.0019 \\ 1 & 70.6952 & 4997.8131 \\ 1 & 193.8189 & 37565.7663 \\ 1 & 155.3396 & 24130.3830 \\ 1 & 199.2726 & 39709.5530\end{matrix} )$$

and solving

$$( {c}_{1} , {c}_{2} , {c}_{3} ) = arg min ( {\sum }_{ω = 1}^{5} {( {Y}_{ω} - Ψ ( M ) ( {X}_{ω} ) )}^{2} )$$

with the scenarios at time t₂ leads to
c₁=−137.9136
c₂=2.2651
c₃=−0.0058
   With the corresponding matrix for the physical scenarios

$${B}_{p} ( {t}_{2} ) = ( \begin{matrix}1 & 120 & 14400 \\ 1 & 100 & 10000 \\ 1 & 80 & 6400\end{matrix} )$$

the option price estimates Bₚ·c evaluate to

| ωₚ | Vₚ(t₂, ωₚ) |
|---|---|
| 1 | 49.77 |
| 2 | 30.17 |
| 3 | 5.90 |

Concluding this first example, we obtain for each physical scenario and each time-step, an option price

| ωₚ | P(t₁, ωₚ) | Vₚ(t₁, ωₚ) | P(t₂, ωₚ) | Vₚ(t₂, ωₚ) |
|---|---|---|---|---|
| 1 | 110 | 54.57 | 120 | 49.77 |
| 2 | 100 | 22.01 | 100 | 30.17 |
| 3 | 90 | −16.87 | 80 | 5.90 |

### Extension 1

The above example can be extended in several ways. First of all, the example can be changed to utilize risk-neutral scenarios starting at different initial values, i.e.

| | | t_{q} | | | |
|---|---|---|---|---|---|
| Q(t_{q}, ω_{q}) | | t₀ | t₁ | t₂ | t₃ |
| ω_{q} | 1 | 80.0000 | 64.1116 | 115.4375 | 105.6911 |
| | 2 | 90.0000 | 41.3639 | 72.6489 | 100.4893 |
| | 3 | 100.0000 | 105.1411 | 103.5702 | 81.8529 |
| | 4 | 110.0000 | 122.1953 | 137.8884 | 316.2593 |
| | 5 | 120.0000 | 83.2175 | 87.7915 | 84.1920 |

These scenarios can be used in the exact same way as before. Using the method with such a risk-neutral scenario set can lead to considerably higher precision of the option prices in extreme physical scenarios.

### Extension 2

Another extension of the above example again considers the risk-neutral scenarios. In some settings it is beneficial to create additional scenarios in the risk-neutral setting at the exact value of the physical scenario, i.e.

| | | t_{q} | | | | |
|---|---|---|---|---|---|---|
| Q(t_{q}, ω_{q}) | | t₀ | t₁ | t₂ | t₃ | I(ω_{q}) |
| ω_{q} | 1 | 100.0000 | 211.7568 | 214.8651 | 106.2542 | t₀ |
| | 2 | 100.0000 | 112.9350 | 70.6952 | 70.8322 | t₀ |
| | 3 | 100.0000 | 154.1112 | 193.8189 | 221.6990 | t₀ |
| | 4 | 100.0000 | 90.2616 | 155.3396 | 121.7245 | t₀ |
| | 5 | 100.0000 | 174.4274 | 199.2726 | 258.4810 | t₀ |
| | 6 | | 110 | 139.2342 | 149.1234 | t₁ |
| | 7 | | 100 | 78.9872 | 90.2324 | t₁ |
| | 8 | | 90 | 98.9079 | 78.2347 | t₁ |
| | 9 | | | 120 | 98.8968 | t₂ |
| | 10 | | | 100 | 76.2563 | t₂ |
| | 11 | | | 80 | 87.2342 | t₂ |

The scenarios 6 to 11 are added to the scenario set \tilde{Ω} in order to fit the physical scenarios 1 to 3. Similar to the first extension of this example, the utilization of the techniques of the present disclosure can ensure higher accuracy for extreme scenarios. Note that scenarios 9-11 are not utilized for the pricing at time-step t₁.

### Extension 3

A third extension to the above example is required for the pricing of a path dependent option. Consider an Asian option, which has a payoff depending on the average asset price until maturity time of the option. This means that the current average Aₚ must be computed in the physical as well as A_{q} in the risk-neutral simulations. For the physical scenarios, Aₚ is given by

| ωₚ | Aₚ(t₀, ωₚ) | Aₚ(t₁, ωₚ) | Aₚ(t₂, ωₚ) |
|---|---|---|---|
| 1 | 100 | 105 | 110 |
| 2 | 100 | 100 | 100 |
| 3 | 100 | 95 | 90 |

and for the risk-neutral scenarios A_{q} is given by

| ω_{q} | A_{q}(t₀, ω_{q}) | A_{q}(t₀, ω_{q}) | A_{q}(t₀, ω_{q}) | A_{q}(t₀, ω_{q}) |
|---|---|---|---|---|
| 1 | 100.0000 | 155.8784 | 175.5406 | 158.2190 |
| 2 | 100.0000 | 106.4675 | 94.5434 | 88.6156 |
| 3 | 100.0000 | 127.0556 | 149.3100 | 167.4073 |
| 4 | 100.0000 | 95.1308 | 115.2004 | 116.8314 |
| 5 | 100.0000 | 137.2137 | 157.9000 | 183.0452 |
| 6 | 100.0000 | 105.0000 | 116.4114 | 124.5894 |
| 7 | 100.0000 | 100.0000 | 92.9957 | 92.3049 |
| 8 | 100.0000 | 95.0000 | 96.3026 | 91.7857 |
| 9 | 100.0000 | 105.0000 | 110.0000 | 107.2242 |
| 10 | 100.0000 | 100.0000 | 100.0000 | 94.0641 |
| 11 | 100.0000 | 95.0000 | 90.0000 | 89.3085 |

Note that the values for l_{q} at time t₂ in scenarios 9 to 11 can be obtained directly from the physical scenarios. This ensures that the added scenarios are consistent with the other scenarios and that they are still increasing the numerical accuracy of the prices in extreme scenarios.

Computing the payoff

V(t,ω_{q})=C(t₃,ω_{q})=max(A_{q}(t₃,ω_{q})−100,0), t=t₁,t₂,t₃

| ω_{q} | V_{q}(t, ω_{q}) |
|---|---|
| 1 | 58.2190 |
| 2 | 0 |
| 3 | 67.4073 |
| 4 | 16.8314 |
| 5 | 83.0452 |
| 6 | 24.5894 |
| 7 | 0 |
| 8 | 0 |
| 9 | 7.2242 |
| 10 | 0 |
| 11 | 0 |

In order to create a simple regression method the data set is set up as M(X,Y)_{ω}_{_{q}}_{εΩ}_{_{q}}, whereas X=(t₁,Q(t₁,ω_{q}),A_{q}(t₁,ω_{q})) and Y=V_{q}(t₁,ω_{q}). The regression is computed as

Ψ(M)=c₁+c₂X₂+c₃(X₂)²+c₄X₃+c₅(X₃)²+c₆X₂X₃

in order to estimate E(Y|X), i.e. the option prices in each scenario.

At time step t₁, this leads to the coefficients
c₁=0
c₂=0
c₃=−0.0510
C₄=0
c₅=−0.0739
c₆=0.1257
   and thus to the option price estimates of

| ωₚ | Vₚ(t₁, ωₚ) |
|---|---|
| 1 | 20.28 |
| 2 | 8.24 |
| 3 | −5.13 |

The option prices Vₚ(t₂,ωₚ) can be obtained correspondingly.

### Fourth Exemplary Embodiment

The following examples demonstrate the speed of the techniques of the present disclosure in a risk-management setting by comparing them with benchmarking methods. In this case study, the Black-Scholes prices of the option is computed in 5,000 physical simulation paths with 250 time steps, i.e. 1,250,000 valuations are performed. The benchmarking methods are:
1. Analytical Solution: In the case of a European Put option, an analytic solution is available. For many other options this is not true, e.g. there are no known analytic solutions for the Asian-American option or Basket-Barrier option.
2. Nested Monte Carlo: Each option valuation is conducted using risk-neutral paths for the option valuation. This method delivers accurate option prices in each scenario but the computational cost is substantial. Consider creating 100,000 risk-neutral paths in each nested simulation. In a realistic setting this requires about 10 s for each of the 1.25 million valuations, i.e. this would take 145 days in total.
3. Nested Monte Carlo (100 path): Is basically the same method as (2), but only 100 nested paths are used for the nested option valuation. The average error in option value of this method is substantial, but as noted by Gordy and Juneja 2008, the risk-measure estimates are sufficiently accurate. In many cases, the errors in the evaluation by only few paths annihilate each other such that the risk estimate is still valid. However, this method is not feasible for option pricing with early exercise.
4. Numerical Solution by PDE: The PDE delivers fast and accurate results for all prices at a specific time step at once and thus serves as a benchmark for the Asian-American option.

The benchmark is performed with three prototypes of financial products:
1. A European Put option which stands for financial products where an efficient analytic solution is available for the stochastic model. In this example the European put option has a strike of 100 and a maturity time of 5 years.
2. An American Asian option which stands for products with no analytic solution available, but there is still an efficient PDE based pricing method. In this example, the American Asian option has 5 years maturity time and the exercise value is the arithmetic average of the previous daily stock prices minus 100.
3. A Basket Barrier option which stands for financial products where there are only Monte Carlo based evaluations known. In this example, the Basket Barrier option is a knock-out option, which is knocked-out if one of the 6 underlings reaches 140. If the option is still alive after 5 years, it pays a weighted average of the performance of the underlying.

### Physical Scenario Setting

5000 physical scenarios with 250 time steps each
5 years with weekly samples
Geometric Brownian Motion (drift=10% p.a., volatility=20%)
5% risk-free interest rate
Examples 1 and 2: stock price S is the single risk-factor (t₀: S=100)
Example 3:stock prices S₁, . . . , S₆ are the risk-factors (t₀: Sᵢ=100, i=1, . . . , 6)

Benchmarking the required time of the different methods for similar reasonable accuracy:

| | | nested Monte | nested Monte | | method |
|---|---|---|---|---|---|
| Option | analytic | Carlo | Carlo | | of this |
| type | solution | (100 paths) | (10.000 paths) | PDE | disclosure |
| European | 0.6 s | 21 s | 342 h(*) | 5 s | 7 s |
| American | n.a. | n.a. | 142 days(*) | 200 s | 80 s |
| Asian | | | | | |
| Basket | n.a. | 72 days(*) | 1 year | n.a. | 376 s |
| Barrier | | | 98 days(*) | | |

reported times are measured on 1 Intel XEON 2, 33 GHz CPU
(*)values are estimates based on the timing of single evaluations

The above table presents that the techniques of the present disclosure are beneficial for option types, for which there is no analytical solution available, i.e. the required time for estimating the 1.25 million option prices of the American Asian option (80 seconds) as well as of the Basket Barrier option (376 seconds) is less than the time required by other methods. Furthermore, the method of this patent is orders of magnitude faster for pricing options for which Monte Carlo simulation is the only known method.

### Fifth Exemplary Embodiment

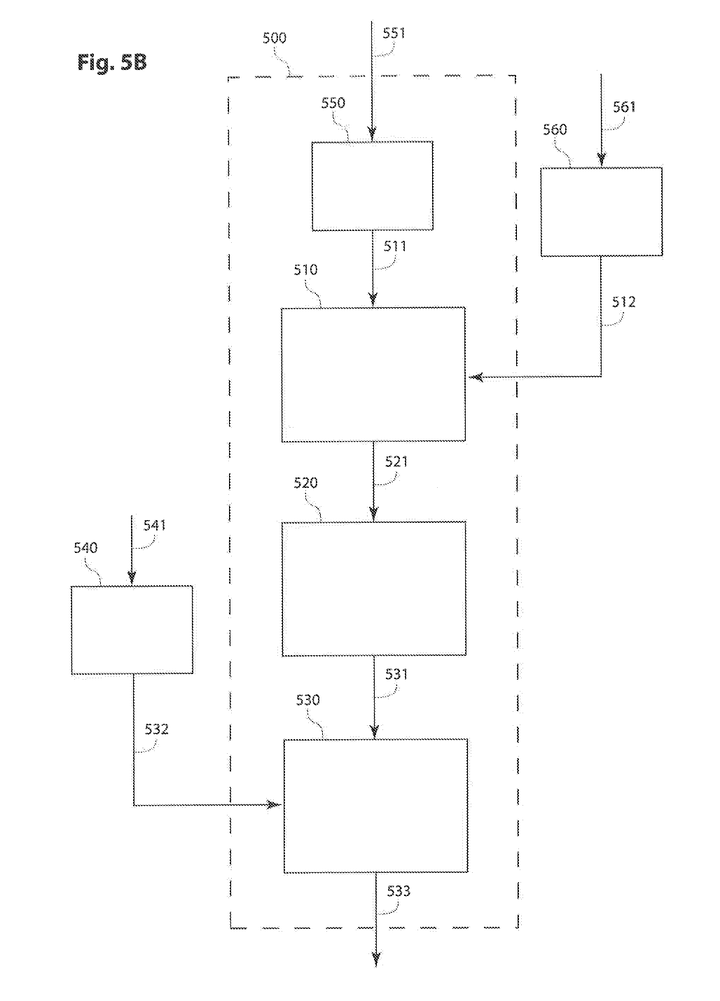

FIG. 5A schematically shows a fifth exemplary embodiment of an apparatus 500 for estimating a yield of a financial product in accordance with the present disclosure.

The illustrated apparatus 500 comprises a calculating system 510, a yield approximation system 520 and a yield estimation system 530. The apparatus can be supported in its operation by a first coordinate set selection system 540, a second coordinate set selection system 550 and a product characterization system 560, any of which may be implemented within the apparatus 500.

The calculating system 510 calculates the yield of the financial product at each of a second plurality of points in a multidimensional space based on a first set of data. The calculation of the yield of the financial product can be based on data indicative of the yield of the financial product under various scenarios. Among other possibilities known to the person skilled in the art, such data may be hardwired into the calculating system 510 or the calculating system may obtain such data in the form of data signals 512. Data signals 521 representing the calculated yield are communicated to the yield approximation system 520.

The yield approximation system 520 generates an approximation function having at least a plurality of variables as input parameters that approximates, for each respective one of the second plurality of points, the yield calculated at each respective one of the second plurality of points by calculating system 510. Data signals 531 representing the generated approximation function are communicated to the yield estimation system 530.

The yield estimation system 530 estimates the yield of the financial product at each of a first plurality of points in a multidimensional space based on the approximation function. The yield estimation system 530 can be configured to output data signals 533 representative of the estimated yield. These data signals 533 can, for example, drive a display, e.g. for presenting the estimated yield to a user, or constitute drive signals for driving a further apparatus (not shown).

The first coordinate set selection system 540 receives input signals 541, on the basis of which the first coordinate set selection system 540 selects the aforementioned first plurality of points that is then used by the yield estimation system 530. Data signals 532 representing the selected first plurality of points are communicated to the yield estimation system 530. The input signals 541 can comprise data signals indicative of the variables that constitute the multidimensional space. The input signals 541 can furthermore comprise user input data. Similarly, the input signals 541 can comprise measurement signals indicative of measurement values obtained from real life measurements, e.g. measurements of the actual market value of one or more commodities at one or more previous points in time. Such measurement values can be transformed into a set of coordinates, i.e. a plurality of points, that is believed to be representative of future market behavior/scenarios.

Similarly, the second coordinate set selection system 550 receives input signals 551, on the basis of which the second coordinate set selection system 550 selects the aforementioned second plurality of points that is then used by the calculating system 510. Data signals 511 representing the selected second plurality of points are communicated to the calculating system 530. The input signals 551 can comprise data signals indicative of the variables that constitute the multidimensional space. The input signals 551 can furthermore comprise user input data. Similarly, the input signals 551 can comprise measurement signals indicative of measurement values obtained from real life measurements, e.g. measurements of the actual market value of one or more commodities at one or more previous points in time. Such measurement values can be transformed into a set of coordinates, i.e. a plurality of points, that is believed to be representative of future market behavior/scenarios.

The second coordinate set selection system 550 may, e.g. on the basis of the aforementioned real life measurements and/or user input, generate a plurality of scenario paths in the multidimensional space by means of a stochastic process, each of the scenario paths comprising a respective third plurality of points in the multidimensional space. The second coordinate set selection system 550 may then choose the second plurality of points by selection, e.g. on the basis of the aforementioned real life measurements and/or user input, at least one of the respective third plurality of points, each of the selected points defining a respective one of the second plurality of points.

The product characterization system 560 receives input signals 561, on the basis of which the product characterization system 560 generates a characterization of the yield of the product under various scenarios, e.g. under various theoretical market conditions and/or on a theoretical product transaction history. In other words, the product characterization system 560 transforms input data representative of the product itself, e.g. the terms and conditions of a contract defining the product, into a representation, e.g. a numeric or mathematical representation, that allows the yield to be calculated by a machine under various scenarios. Data signals 512 representing the generated characterization are communicated to the calculating system 510.

The aforementioned elements of apparatus 500 can be implemented as separate elements or as a combined structure. As discussed in the introductory portion of this disclosure, the apparatus, i.e. calculating circuitry constituting the apparatus, can be embodied using dedicated hardware and/or programmable hardware.

FIG. 5B shows a modified form of the fifth exemplary embodiment shown in FIG. 5A. The modified embodiment shown in FIG. 5B differs from the embodiment shown in FIG. 5A solely in that the second coordinate set selection system 550 is comprised within the apparatus 500.

The preceding disclosure can be summarized as follows:
Item 1. A computer-implemented method for the evaluation of a financial product under more than one tuples for the input data using Monte-Carlo simulation. The input data is given as a set P of physical scenarios, containing data tuples associated to different scenarios and different time steps. The tuples contain risk factors determining the price. The algorithm comprises the steps of
   (i) Generation of scenario paths Q from a stochastic model as risk-factor tuples, used for the product price estimation
   (ii) Compute path-dependent variables for each scenario and each time step of P, containing all pricing relevant product specific information known at that time
   (iii) Compute path-dependent variables for each scenario and each time step of Q, containing all pricing relevant product specific information known at that time
   (iv) Compute Vas the cumulated remaining cash value of the cash-flows in each scenario and each time step of Q.
   (v) Estimate one or more smoothing functions on scenarios of Q and path-dependent variables, smoothing the cash value V.
   (vi) For each tuple in P the product price is evaluated from the associated smoothing function from step (v) at the associated time step, the associated path-dependent variable and the tuple value.
Item 2. The method of Item 1 where P are physical and Q risk-neutral scenario paths according to the option pricing theory.
Item 3. The method of Item 1 where P and Q are physical paths according to the option pricing theory with an estimator for product prices based on Q.
Item 4. The method of Item 3, where the product pricing is conducted with Simulation-Based Hedging
Item 5. The method of any one of the preceding Items where the smoothing procedure is a semi-parametric regression
Item 6. The method of any one of Items 1 to 4 where the smoothing procedure is non-parametric regression
Item 7. The method of Item 6 with sparse grid basis functions.
Item 8. The method of Item 6 with thin-plate spline basis functions.
Item 9. The method of Item 6 with b-spline basis functions.
Item 10. The method of any one of Items 1 to 4 where the smoothing procedure is kernel smoothing
Item 11. The method of any one of the preceding Items where the smoothing procedure is applied once and for all required physical tuples.
Item 12. The method of any one of the preceding Items, where the scenario paths from step (ii) start with a risk-factor tuple from P and follow a stochastic process after the time step of the tuple.
Item 13. The method of any one of Items 1-11, where the scenario paths from step (ii) start at appropriate risk-factor values covering the range of the physical tuples. For each time step there are tuples from step (ii) outside the range of physical tuples.
Item 14. The method of any one of the preceding Items, where the scenario paths from step (ii) and the associated path dependent variables are made persistent such that later computations of smoothing function can be performed efficiently.
Item 15. The method of any one of the preceding Items, where the smoothing function from step (vi) is made persistent such that later computations of product prices for new risk factor tuples can be performed efficiently.
Item 16. The method of Item 14 or 15, where additional scenarios for step (ii) are computed on demand, based on an error estimate for the price generated at the new risk factor tuples.
Item 17. An apparatus for estimating a yield of a financial product, said apparatus having calculating circuitry that:
   receives a first set of data indicative of a yield of said financial product as a function of a plurality of variables and time;
   receives a first plurality of points in a multidimensional space having said plurality of variables and time as coordinates;
   calculates said yield of said product at each of a second plurality of points in said multidimensional space based on said first set of data;
   generates an approximation function having at least said plurality of variables as input parameters that approximates, for each respective one of said second
   plurality of points, said calculated yield at said respective one of said second plurality of points; and
   estimates a yield of said financial product at each of said first plurality of points based on said approximation function.
Item 18. The apparatus of Item 17, wherein, for said calculating of said yield, said calculating circuitry:
   generates a plurality of scenario paths in said multidimensional space by means of a stochastic process, each of said scenario paths comprising a respective, third plurality of points in said multidimensional space, and
   chooses said second plurality of points by selecting, for each of said plurality of scenario paths, at least one of said respective, third plurality of points, each of said selected points defining a respective one of said second plurality of points.
Item 19. The apparatus of Item 18, wherein said calculating circuitry:
   receives, for each respective one of said plurality of variables, a second set of data indicative of a risk-neutral probability distribution of said respective one of said plurality of variables;
   receives a set of coordinates indicative of a starting point in said multidimensional space; and wherein
   said calculating circuitry, for said generating of said plurality of scenario paths:
   calculates, for each respective one of said scenario paths, a sequence of scenario points having coordinates in said multidimensional space that defines said respective one of said scenario paths by an iterative process that, starting from said starting point as a first scenario point in said sequence, calculates each respective one of said coordinates of each respective next scenario point of said sequence by means of a Monte Carlo technique based on said respective one of said coordinates of a respective scenario point that immediately precedes said respective next scenario point in said sequence and said second set of data for a variable corresponding to said respective one of said coordinates.
Item 20. The apparatus of any one of Items 17-19, wherein said approximation function has said plurality of variables as input parameters.
Item 21. The apparatus of Item 20, wherein said calculating circuitry generates said approximation function by calculating, as said approximation function, an approximating function that minimizes a value obtained by summing, for each respective one of said variables, the product of a weighting value and a sum, said sum being obtained by summing, for each respective one of said second plurality of points, the square of the difference between said approximating function and said calculated yield at said respective one of said second plurality of points.
Item 22. The apparatus of any of Items 17-19, wherein said approximation function has said plurality of variables and time as input parameters.
Item 23. The apparatus of Item 21, wherein said calculating circuitry generates said approximation function by calculating, as said approximation function, an approximating function that minimizes a value obtained by summing, for each respective one of said variables and time, the product of a weighting value and a sum, said sum being obtained by summing, for each respective one of said second plurality of points, the square of the difference between said approximating function and said calculated yield at said respective one of said second plurality of points.
Item 24. The apparatus of any one of Items 17-21, wherein said time coordinate of any one of said second plurality of points is identical to said time coordinate of any other one of said second plurality of points.
Item 25. The apparatus of any one of Items 17-24, wherein said first plurality of points comprises at least 5000 points, said second plurality of points comprises at least 8000 points and said plurality of variables comprises at least 5 variables.
Item 26. An apparatus for estimating yield of a financial product, comprising a calculating unit that:
   generates a plurality of paths in a multidimensional space by means of a stochastic process,
   selects a first plurality of points by means of a sampling process, each of said first plurality of points falling within a predetermined range with respect to at least one coordinate of said multidimensional space and being coincident with at least one of said plurality of paths,
   calculates a yield of said financial product at each of said first plurality of points,
   generates an approximation function that approximates, in said multidimensional space, said yield at each of said first plurality of points, and
   estimates a yield of said financial product at each of a second plurality of points by evaluating said approximation function at each of said second plurality of points.
Item 27. A computer program product for estimating a yield of a financial product, said product being configured and adapted to effect, when executed on a computer, the steps of:
   receiving a first set of data indicative of a yield of said financial product as a function of a plurality of variables and time;
   receiving a first plurality of points in a multidimensional space having said plurality of variables and time as coordinates;
   calculating said yield of said product at each of a second plurality of points in said multidimensional space based on said first set of data;
   generating an approximation function having at least said plurality of variables as input parameters that approximates, for each respective one of said second plurality of points, said calculated yield at said respective one of said second plurality of points; and
   estimating a yield of said financial product at each of said first plurality of points based on said approximation function.
Item 28. A computer program product for estimating a yield of a financial product, said product being configured and adapted to effect, when executed on a computer, the steps of:
   generating a plurality of paths in a multidimensional space by means of a stochastic process,
   selecting a first plurality of points by means of a sampling process, each of said first plurality of points falling within a predetermined range with respect to at least one coordinate of said multidimensional space and being coincident with at least one of said plurality of paths,
   calculating a yield of said financial product at each of said first plurality of points,
   generating an approximation function that approximates, in said multidimensional space, said yield at each of said first plurality of points, and
   estimating a yield of said financial product at each of a second plurality of points by evaluating said approximation function at each of said second plurality of points.
Item 29. A method for estimating a yield of a financial product, said method comprising the steps of:
   receiving a first set of data indicative of a yield of said financial product as a function of a plurality of variables and time;
   receiving a first plurality of points in a multidimensional space having said plurality of variables and time as coordinates;
   calculating said yield of said product at each of a second plurality of points in said multidimensional space based on said first set of data;
   generating an approximation function having at least said plurality of variables as input parameters that approximates, for each respective one of said second plurality of points, said calculated yield at said respective one of said second plurality of points; and
   estimating a yield of said financial product at each of said first plurality of points based on said approximation function.
Item 30. A method for estimating a yield of a financial product, said method comprising the steps of:
   generating a plurality of paths in a multidimensional space by means of a stochastic process,
   selecting a first plurality of points by means of a sampling process, each of said first plurality of points falling within a predetermined range with respect to at least one coordinate of said multidimensional space and being coincident with at least one of said plurality of paths,
   calculating a yield of said financial product at each of said first plurality of points,
   generating an approximation function that approximates, in said multidimensional space, said yield at each of said first plurality of points, and
   estimating a yield of said financial product at each of a second plurality of points by evaluating said approximation function at each of said second plurality of points.
Item 31. An apparatus for estimating a yield of a financial product, said apparatus comprising:
   means configured and adapted for receiving a first set of data indicative of a yield of said financial product as a function of a plurality of variables and time;
   means configured and adapted for receiving a first plurality of points in a multidimensional space having said plurality of variables and time as coordinates;
   means configured and adapted for calculating said yield of said product at each of a second plurality of points in said multidimensional space based on said first set of data;
   means configured and adapted for generating an approximation function having at least said plurality of variables as input parameters that approximates, for each respective one of said second plurality of points, said calculated yield at said respective one of said second plurality of points; and
   means configured and adapted for estimating a yield of said financial product at each of said first plurality of points based on said approximation function.
Item 32. An apparatus for estimating a yield of a financial product, said apparatus comprising:
   means configured and adapted for generating a plurality of paths in a multidimensional space by means of a stochastic process,
   means configured and adapted for selecting a first plurality of points by means of a sampling process, each of said first plurality of points falling within a predetermined range with respect to at least one coordinate of said multidimensional space and being coincident with at least one of said plurality of paths,
   means configured and adapted for calculating a yield of said financial product at each of said first plurality of points,
   means configured and adapted for generating an approximation function that approximates, in said multidimensional space, said yield at each of said first plurality of points, and
   means configured and adapted for estimating a yield of said financial product at each of a second plurality of points by evaluating said approximation function at each of said second plurality of points.

### BIBLIOGRAPHY

Further information with regard to the terminology used in this specification as well as techniques and hardware employable for implementing the known features of the present disclosure can be found in the documents cited in this bibliography, the contents of which are incorporated herein by reference.
P. A. Abken 2000, Value at Risk by Scenario Simulation, Journal of Derivatives, http://www.gloriamundi.org/picsresources/pa.pdf
R. M. Bethea, B. S. Duran and T. L. Boullion. Statistical Methods for Engineers and Scientists. New York: Marcel Dekker, Inc 1985 ISBN 0-8247-7227-X
R. Dembo et al 2001, Computer-implemented method and apparatus for portfolio compression, U.S. Pat. No. 6,278,981
S. Dirnstorfer, A. J. Grau 2006, R. Zagst Moving Window Asian Options: Sparse Grids and Least-Squares Monte Carlo, working paper, grau@ma.tum.de
D. A. Freedman, Statistical Models: Theory and Practice, Cambridge University Press (2005)
J. Garcke, M. Griebel and M. Thess 2001, Data mining with sparse grids, Computing, 67, 225-253.
P. Glassermann 2000, Efficient Monte Carlo Methods for Value-at-Risk, IBM Research Division, RC 21723 (97823)
P. Glasserman 2003, Monte Carlo Methods in Financial Engineering. Springer, Berlin.
M. B. Gordy and S. Juneja 2008, Nested Simulation in Portfolio Risk Measurement, Finance and Economics Discussion Series, Divisions of Research & Statistics and Monetary Affairs, Federal Reserve Board, Washington, D.C., 2008-21
A. J. Grau 2008, Applications of Least-Squares Regressions to Pricing and Hedging of Financial Derivatives, Dissertation, Technische Universität München, http://nbn-resolving.de/urn/resolver.pl?urn:nbn:de:bvb:91-diss-20071212-635889-1-9
W. Härdle 1994, Applied Nonparametric regression, http://www.quantlet.com/mdstat/scripts/anr/pdf/anrpdf.pdf
S. Heston 1993, A Closed-Form Solution for Options with Stochastic Volatility with Applications to Bond and Currency Options, Review of Financial Studies, 6, pp. 327-343.
C. R. Rao, H. Toutenburg, A. Fieger, C. Heumann, T. Nittner and S. Scheid, Linear Models: Least Squares and Alternatives, Springer Series in Statistics, 1999
J. F. Traub 1999, S. Paskov, I. F. Vanderhoof Estimation method and system for complex securities using low-discrepancy deterministic sequences, U.S. Pat. No. 5,940,810
J. Wolberg, Data Analysis Using the Method of Least Squares: Extracting the Most Information from Experiments, Springer, 2005

What is claimed is:

1. An apparatus for estimating a yield of a financial product, said apparatus having calculating circuitry that:
receives a first set of data indicative of a yield of said financial product as a function of a plurality of variables and time;
receives a first plurality of points in a multidimensional space having said plurality of variables and time as coordinates;
calculates said yield of said product at each of a second plurality of points in said multidimensional space based on said first set of data;
generates an approximation function having at least said plurality of variables as input parameters that approximates, for each respective one of said second plurality of points, said calculated yield at said respective one of said second plurality of points; and
estimates a yield of said financial product at each of said first plurality of points based on said approximation function.

2. The apparatus of claim 1, wherein, for said calculating of said yield, said calculating circuitry:
generates a plurality of scenario paths in said multidimensional space by means of a stochastic process, each of said scenario paths comprising a respective, third plurality of points in said multidimensional space, and
chooses said second plurality of points by selecting, for each of said plurality of scenario paths, at least one of said respective, third plurality of points, each of said selected points defining a respective one of said second plurality of points.

3. The apparatus of claim 2, wherein said calculating circuitry:
receives, for each respective one of said plurality of variables, a second set of data indicative of a risk-neutral probability distribution of said respective one of said plurality of variables;
receives a set of coordinates indicative of a starting point in said multidimensional space; and wherein
said calculating circuitry, for said generating of said plurality of scenario paths:
calculates, for each respective one of said scenario paths, a sequence of scenario points having coordinates in said multidimensional space that defines said respective one of said scenario paths by an iterative process that, starting from said starting point as a first scenario point in said sequence, calculates each respective one of said coordinates of each respective next scenario point of said sequence by means of a Monte Carlo technique based on said respective one of said coordinates of a respective scenario point that immediately precedes said respective next scenario point in said sequence and said second set of data for a variable corresponding to said respective one of said coordinates.

4. The apparatus of claim 1, wherein said approximation function has said plurality of variables as input parameters.

5. The apparatus of claim 4, wherein said calculating circuitry generates said approximation function by calculating, as said approximation function, an approximating function that minimizes a value obtained by summing, for each respective one of said variables, the product of a weighting value and a sum, said sum being obtained by summing, for each respective one of said second plurality of points, the square of the difference between said approximating function and said calculated yield at said respective one of said second plurality of points.

6. The apparatus claim 1, wherein said approximation function has said plurality of variables and time as input parameters.

7. The apparatus of claim 6, wherein said calculating circuitry generates said approximation function by calculating, as said approximation function, an approximating function that minimizes a value obtained by summing, for each respective one of said variables and time, the product of a weighting value and a sum, said sum being obtained by summing, for each respective one of said second plurality of points, the square of the difference between said approximating function and said calculated yield at said respective one of said second plurality of points.

8. The apparatus of claim 1, wherein said time coordinate of any one of said second plurality of points is identical to said time coordinate of any other one of said second plurality of points.

9. The apparatus of claim 1, wherein said first plurality of points comprises at least 5000 points, said second plurality of points comprises at least 8000 points and said plurality of variables comprises at least 5 variables.

10. An apparatus for estimating yield of a financial product, comprising a calculating unit that:
generates a plurality of paths in a multidimensional space by means of a stochastic process,
selects a first plurality of points by means of a sampling process, each of said first plurality of points falling within a predetermined range with respect to at least one coordinate of said multidimensional space and being coincident with at least one of said plurality of paths,
calculates a yield of said financial product at each of said first plurality of points,
generates an approximation function that approximates, in said multidimensional space, said yield at each of said first plurality of points, and
estimates a yield of said financial product at each of a second plurality of points by evaluating said approximation function at each of said second plurality of points.

11. A computer program product for estimating a yield of a financial product, said product being configured and adapted to effect, when executed on a computer, the steps of:
receiving a first set of data indicative of a yield of said financial product as a function of a plurality of variables and time;
receiving a first plurality of points in a multidimensional space having said plurality of variables and time as coordinates;
calculating said yield of said product at each of a second plurality of points in said multidimensional space based on said first set of data;
generating an approximation function having at least said plurality of variables as input parameters that approximates, for each respective one of said second plurality of points, said calculated yield at said respective one of said second plurality of points; and
estimating a yield of said financial product at each of said first plurality of points based on said approximation function.

12. A computer program product for estimating a yield of a financial product, said product being configured and adapted to effect, when executed on a computer, the steps of:
generating a plurality of paths in a multidimensional space by means of a stochastic process,
selecting a first plurality of points by means of a sampling process, each of said first plurality of points falling within a predetermined range with respect to at least one coordinate of said multidimensional space and being coincident with at least one of said plurality of paths,
calculating a yield of said financial product at each of said first plurality of points,
generating an approximation function that approximates, in said multidimensional space, said yield at each of said first plurality of points, and
estimating a yield of said financial product at each of a second plurality of points by evaluating said approximation function at each of said second plurality of points.

13. A method for estimating a yield of a financial product, said method comprising the steps of:
receiving a first set of data indicative of a yield of said financial product as a function of a plurality of variables and time;
receiving a first plurality of points in a multidimensional space having said plurality of variables and time as coordinates;
calculating said yield of said product at each of a second plurality of points in said multidimensional space based on said first set of data;
generating an approximation function having at least said plurality of variables as input parameters that approximates, for each respective one of said second plurality of points, said calculated yield at said respective one of said second plurality of points; and
estimating a yield of said financial product at each of said first plurality of points based on said approximation function.

14. A method for estimating a yield of a financial product, said method comprising the steps of:
generating a plurality of paths in a multidimensional space by means of a stochastic process,
selecting a first plurality of points by means of a sampling process, each of said first plurality of points falling within a predetermined range with respect to at least one coordinate of said multidimensional space and being coincident with at least one of said plurality of paths,
calculating a yield of said financial product at each of said first plurality of points, generating an approximation function that approximates, in said multidimensional space, said yield at each of said first plurality of points, and
estimating a yield of said financial product at each of a second plurality of points by evaluating said approximation function at each of said second plurality of points.
